(19) United States
(12) Patent Application Publication
(10) Pub. No.: US 2013/0223526 A1
(43) Pub. Date: Aug. 29, 2013

(54) IMAGE DECODING METHOD, IMAGE CODING METHOD, IMAGE DECODING DEVICE, IMAGE CODING DEVICE, AND RECORDING MEDIUM

(71) Applicant: FUJITSU LIMITED, (US)

(72) Inventors: Hidenobu MIYOSHI, Kawasaki (JP); Junpei KOYAMA, Shibuya (JP); Kimihiko KAZUI, Kawasaki (JP); Satoshi SHIMADA, Kawasaki (JP); Akira NAKAGAWA, Sagamihara (JP)

(73) Assignee: FUJITSU LIMITED, Kawasaki-shi (JP)

(21) Appl. No.: 13/851,255

(22) Filed: Mar. 27, 2013

Related U.S. Application Data
(63) Continuation of application No. PCT/JP2010/067170, filed on Sep. 30, 2010.

(51) Int. Cl. H04N 7/26

(52) U.S. Cl. CPC H04N 19/00569
USPC 375/240.12

(57) ABSTRACT

A method for decoding an image divided into plural blocks includes acquiring decoding information of a decoded block in a decoding target image from a storage unit that stores the decoding information of the decoded block and decoding information of blocks in plural decoded images; selecting a decoded image from the plural decoded images; acquiring decoding information of a corresponding block in the selected decoded image from the storage unit; predicting a division mode, which indicates a division shape of a decoding target block, by using the acquired decoding information of the decoded block and the acquired decoding information of the corresponding block; decoding division mode information, which indicates the division mode of the decoding target block based on coded data, and determining the division mode of the decoding target block based on the predicted division mode and the decoded division mode information.

### CROSS-REFERENCE TO RELATED APPLICATION

This application is a continuation application of International Application PCT JP2010/067170 filed on Sep. 30, 2010 and designated the U.S., the entire contents of which are incorporated hereby reference.

### FIELD

The embodiments discussed herein are related to an image decoding method, an image coding method, an image decoding device, an image coding device, and a recording medium.

### BACKGROUND

Generally, a data amount of image data, especially moving image data, is large. Therefore, highly efficient coding is performed when, for example, such data are transmitted from a transmitting device to a receiving device or stored in a storage device. Here, the term “highly efficient coding” refers to a coding process where a data string is converted into a different data string to reduce its data amount.

There are types of moving image data that are mainly composed of frames and moving image data that are composed of fields.

As a highly efficient coding method of moving image data, there has been known an intra-picture prediction (intra prediction) coding method. This method uses a fact that moving image data have higher correlation in a spatial direction and does not use coded image data of other pictures. Accordingly, the intra-picture prediction coding method makes it possible to decode image data based only on information within a picture.

Further, there has also been known an inter-picture prediction (inter prediction) coding method. This coding method uses a fact that the moving image data have higher correlation in a temporal direction. In moving image data, there is typically higher similarity between picture data at a certain timing and picture data at the next timing (i.e., between pictures adjacent to each other in temporal direction). The inter-picture prediction coding method uses this characteristic of moving image data.

Further, in the inter-picture prediction coding method, an original image is divided into blocks. Then, a region similar to each original image block is selected from a decoded image of a coded frame.

FIG. 1 illustrates an example that the original image is divided into blocks. The block MB in FIG. 1 refers to a Macro Block. As illustrated in FIG. 1, the original image is divided into plural macro blocks.

Next, a difference is obtained between the similar region of the original image block and the original image block, so as to remove redundancy. Further, by coding motion vector information indicating the similar region and difference information in which the redundancy is removed, a higher compression rate is achieved.

For example, in a data transmission system using the inter prediction coding method, the transmission device generates the motion vector data, which indicates the “motion” from the previous picture to the target picture, and the difference data between the prediction image of the target picture, which is generated by using the motion vector from the previous picture, and the target picture.

Next, in the data transmission system, the generated motion vector data and the difference data to the receiving device. Then, based on the received motion vector data and the difference data, the receiving device reproduces the target picture.

As typical moving image coding methods, there are ISO/IEC (ISO/IEC: International Organization for Standardization/International Electrotechnical Commission) MPEG (Moving Picture Experts Group)-2/MPEG-4.

In the moving image coding methods, a group of pictures (GOP) structure is employed in which intra prediction coded images are periodically transmitted and others are transmitted based on the inter prediction coding. Further, three types of pictures I, P, and B corresponding to those predictions are determined.

The I picture is generated without using any coded images of other pictures and based only on the data within the picture. The P picture is a picture generated by coding the prediction error which is based on the inter picture prediction in the forward direction from the past picture.

The B picture is a picture generated by coding the prediction error which is based on the inter picture prediction in a forward direction from the past and in a backward direction from the future picture. The B picture uses the future picture for the prediction. Therefore, before the coding, it is desired to code and decode the future picture to be used for the prediction.

FIG. 2 illustrates the B picture which refers to decoding images in forward and backward directions. As illustrated in FIG. 2, when the B picture Pic2 to be coded is coded, at least two pictures Pic1 and Pic3, which are the pictures before and after the picture Pic2, have already been coded. The B picture Pic2 to be coded may select either the forward-direction reference image Pic1 or the backward-direction reference image Pic3 or both.

For example, by using the block matching technique, a region most similar to the coding target block CB1 in the forward-direction reference image Pic1 is calculated as the forward-direction prediction block FB1, and a region most similar to the coding target block CB1 in the backward-direction reference image Pic3 is calculated as the backward-direction prediction block BB1.

When bi-direction is selected, the bi-directional information in the prediction directions, the motion vector MV1, 2 from the position (collocated block Colb1,2) same as that of the coding target block CB1 in both reference images, and the pixel difference between coding target block CB1 and the prediction block are coded.

FIG. 3 illustrates an example of a first GOP structure. The GOP structure in FIG. 3 illustrates an IBBP structure of a general GOP structure. In MPEG-2, the coded image to be used as the reference image of B picture is desired to be coded as the P or I picture.

However, in addition to the above, in ITU-T H264 (ITU-T: International Telecommunication Union Telecommunication Standardization Sector)/IO/IEC MPEG-4AVC (hereinafter “H.264”) which is the latest coding method, it becomes possible to use the coded image coded in B picture as the reference image.

FIG. 4 illustrates an example of a second GOP structure. In the H.264 for coding a moving picture, the GOP structure as illustrated in FIG. 4 may be used. As a result, the coding efficiency has been improved. This GOP structure may be called a “hierarchical B structure”.

As illustrated in FIG. 4, in the GOP structure, the number of B pictures is increased. Therefore, the improvement of efficiency in coding B pictures directly contributes to the improvement of the coding efficiency of the entire moving image coding. The arrows in FIGS. 3 and 4 denote the forward or backward direction.

FIG. 5 illustrates an example of a block structure. In the H.264, to improve the compression efficiency, the macro block having 16×16 pixels is further divided into small partitions (sub macro blocks) as illustrated in FIG. 5, so that the motion vector may be acquired per sub macro block.

As the unit of the partition as the macro block partition, there are 16×16 pixels (see part (A) of FIG. 5), 16×8 pixels (see part (B) of FIG. 5), 8×16 pixels (see part (C) of FIG. 5), and 8×8 pixels (see part (D) of FIG. 5).

Further, when the macro block has 8×8 pixels, it is possible to select a partition unit as the sub macro block partition from among 8×8 pixels, 8×4 pixels, 4×8 pixels, and 4×4 pixels (see also part (D) of FIG. 5).

Further, as a technique which is proposed in the next-generation moving image coding HEVC (High Efficiency Video Coding) discloses the division units as illustrated in FIG. 6. FIG. 6 illustrates an example of block structure used in the next-generation moving image coding.

FIG. 6 illustrates a Coding unit (CU) corresponding to a conventional macro block, a Prediction Unit (PU) formed by dividing the CU into partitions as a prediction unit, and a Transform Unit (TU) formed by dividing the CU into partitions as a frequency unit. Further, a division flag is used to divide the block, so as to be checked to determine whether the block is divided.

Reference may be made for Joint Collaborative Team on Video Coding (JCT-VC) of ITU-T SG16 WP3 and ISO/IEC JTC1/SC29/WG11, 1st Meeting: Dresden, Del., 15-23 Apr. 2010, Samsung's Response to the Call for Proposals on Video Compression Technology/JCTVC-A124, P. 7-10.

### SUMMARY

According to an embodiment, a method for decoding an image divided into plural blocks includes acquiring decoding information of a decoded block in a decoding target image from a storage unit that stores the decoding information of the decoded block and decoding information of blocks in plural decoded images; selecting a decoded image from the plural decoded images; acquiring decoding information of a corresponding block in the selected decoded image from the storage unit; predicting a division mode, which indicates a division shape of a decoding target block, by using the acquired decoding information of the decoded block and the acquired decoding information of the corresponding block; decoding division mode information, which indicates the division mode of the decoding target block based on coded data, and determining the division mode of the decoding target block based on the predicted division mode and the decoded division mode information.

The objects and advantages of the embodiments disclosed herein will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 illustrates an example where an original image is divided into blocks;

FIG. 2 illustrates a B picture which refers to decoded images in forward and backward directions;

FIG. 3 illustrates an example of a first GOP structure;

FIG. 4 illustrates an example of a second GOP structure;

FIG. 5 illustrates an example block structure in H.264;

FIG. 6 illustrates an example block structure in next-generation moving image coding;

FIG. 7 illustrates spatial correlation;

FIG. 8 is a block diagram illustrating an example configuration of an image coding device according to a first embodiment;

FIG. 9 is a block diagram illustrating an example prediction function of a division mode according to the first embodiment;

FIG. 10 is a block diagram illustrating an example function of a prediction unit;

FIG. 11 is a block diagram illustrating an example configuration of an image coding device according to a second embodiment;

FIG. 12 is a block diagram illustrating an example prediction function of the division mode according to a second embodiment;

FIG. 13 illustrates a hierarchical structure of a Quad tree;

FIG. 14 illustrates an example GOP structure (IBBP structure) according to a third embodiment;

FIG. 15 illustrates an example relationship between the coding target block and a surrounding block;

FIG. 16 illustrates a distance between the coding target image and a reference image;

FIG. 17 illustrates a block acquired by a second acquisition unit;

FIG. 18 illustrates an example comparison by the prediction unit;

FIG. 19 illustrates another example comparison by the prediction unit;

FIG. 20 illustrates an example inconsistency flag;

FIG. 21 is an example flowchart of a division mode coding process according to a third embodiment;

FIG. 22 is an example flowchart of a division mode decoding process according to a fourth embodiment;

FIG. 23 illustrates an example GOP structure (hierarchical B structure) according to a fifth embodiment;

FIG. 24 is a block diagram illustrating an example prediction function of the division mode according to a fifth embodiment;

FIG. 25 illustrates an example picture distance;

FIG. 26 illustrates example coding information acquired by a first acquisition unit;

FIG. 27 illustrates an example provisional motion vector;

FIG. 28 illustrates an example coding table;

FIG. 29 is an example flowchart of division mode coding process according to a fifth embodiment;

FIG. 30 is a block diagram illustrating an example prediction function of the division mode according to a sixth embodiment;

FIG. 31 is an example flowchart of division mode decoding process according to a sixth embodiment;

FIG. 32 is a block diagram illustrating an example prediction function of the division mode according to a seventh embodiment;

FIG. 33 illustrates example surrounding blocks;

FIG. 34 illustrates an example surrounding block designated by the second acquisition unit;

FIG. 35 illustrates a block acquired by the second acquisition unit;

FIG. 36 is a block diagram illustrating an example function of the prediction unit;

FIG. 37A is a flowchart of an example first division mode coding process according to the seventh embodiment;

FIG. 37B is a flowchart of an example second division mode coding process according to the seventh embodiment;

FIG. 38 is a block diagram illustrating an example prediction function of the division mode according to an eighth embodiment;

FIG. 39A is a flowchart of an example first division mode decoding process according to the eighth embodiment;

FIG. 39B is a flowchart of an example second division mode decoding process according to the eighth embodiment; and

FIG. 40 illustrates an example configuration of an information processing apparatus.

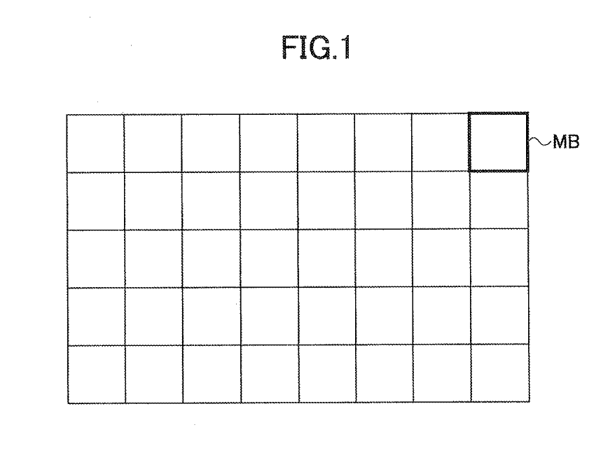

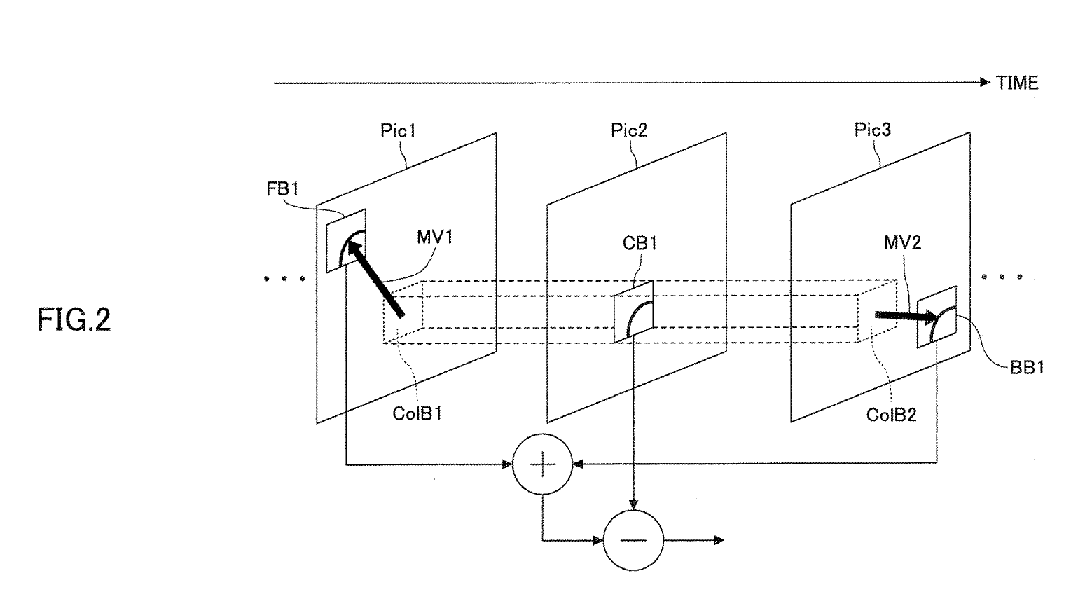

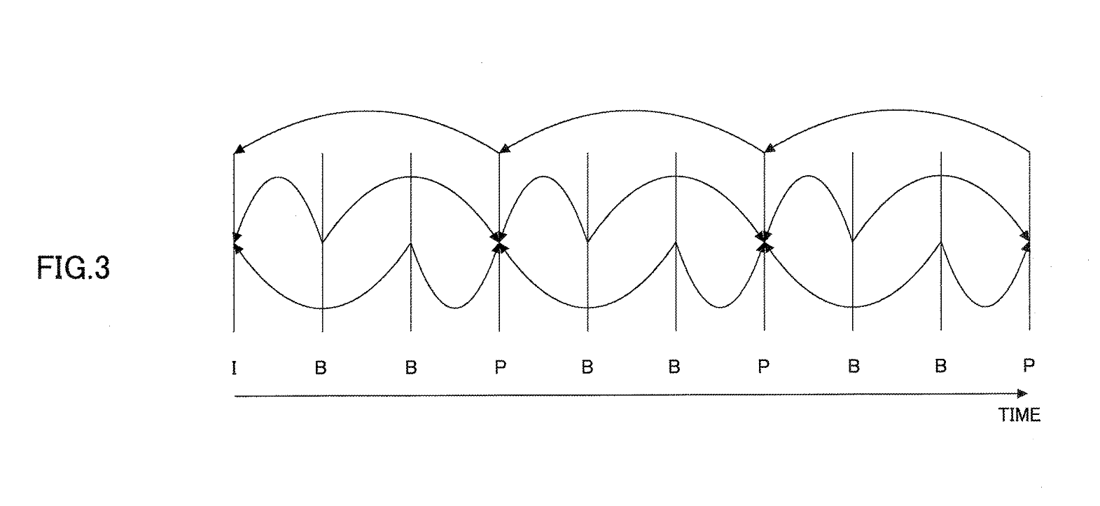

### DESCRIPTION OF EMBODIMENTS

Conventionally, a structure of coding target block, a frequency conversion method and the like are reported to the decoder side. Therefore, such division mode information is explicitly transmitted as a bit stream. On the other hand, there are various coding modes are added. Therefore, the overhead to report such coding modes may become a cause of impeding the improvement of coding efficiency.

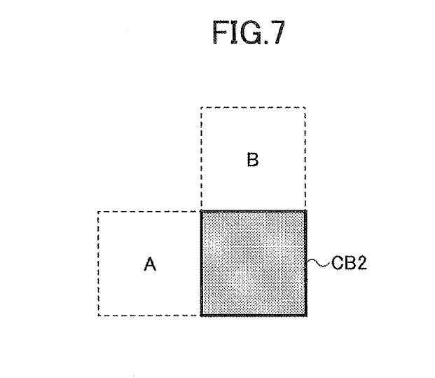

FIG. 7 illustrates spatial correlation. For example, in arithmetic coding, when the coding target block CB2 is coded, probability of occurrence is updated by using the spatial correlation of the prediction mode information (e.g., inter prediction or intra prediction) of surrounding coded blocks A and B.

However, the prediction may be made based on only the state of surrounding blocks of the coding target block in the same picture (i.e., based on only spatial correlation). As a result, depending on, for example, the characteristics of the image, an appropriate prediction with respect to the division mode indicating the division shape of the image may not be made, and the compression rate may be reduced.

According to an embodiment of the present invention, there are provided an image decoding method, an image coding method, an image decoding device, an image coding device, an image decoding program, an image coding program, and recording medium that may become possible to improve the accuracy of the prediction of the division mode, and also improve coding/decoding efficiency of an image.

In the following, embodiments are described with reference to the accompanying drawings.

### First Embodiment

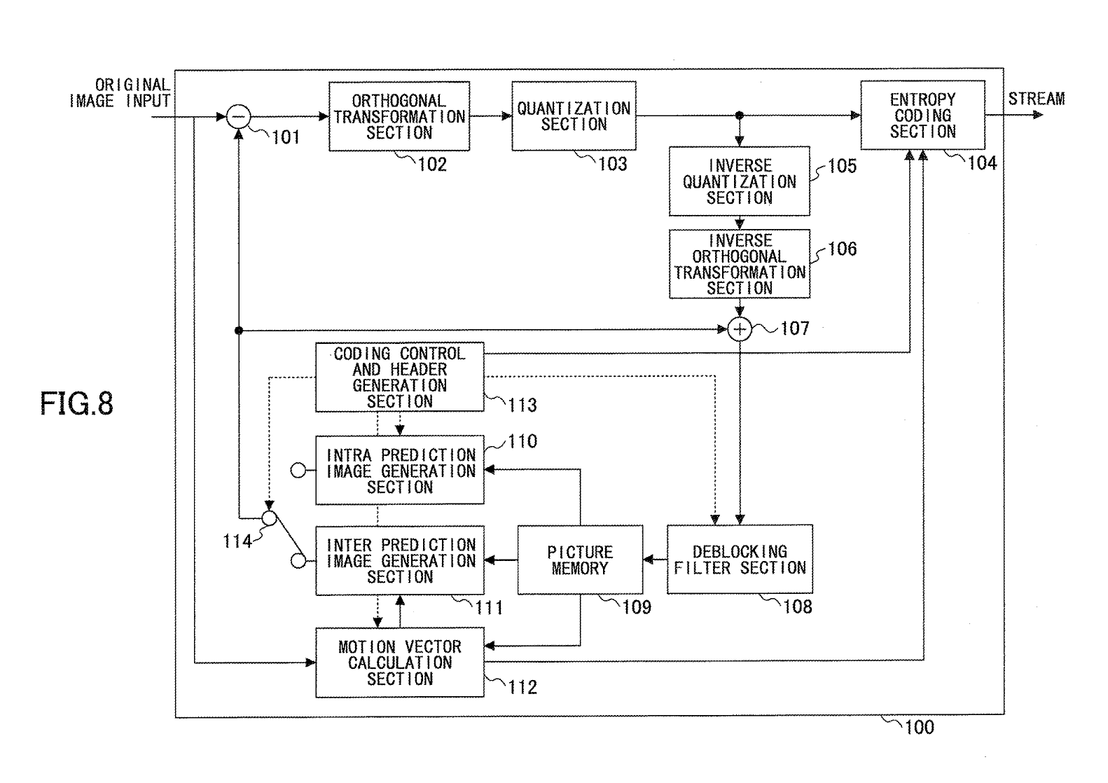

FIG. 8 is a block diagram of an example configuration of an image coding device 100 according to a first embodiment. As illustrated in FIG. 8, the image coding device 100 according to the first embodiment includes a prediction error signal generation section 101, an orthogonal transformation section 102, a quantization section 103, and an entropy coding section 104, an inverse quantization section 105, an inverse orthogonal transformation section 106, a decoded image generation section 107, a deblocking filter section 108, a picture memory 109, an intra prediction image generation section 110, an inter prediction image generation section 111, a motion vector calculation section 112, a coding control and header generation section 113, and a prediction image selection section 114. Details of those elements are described below.

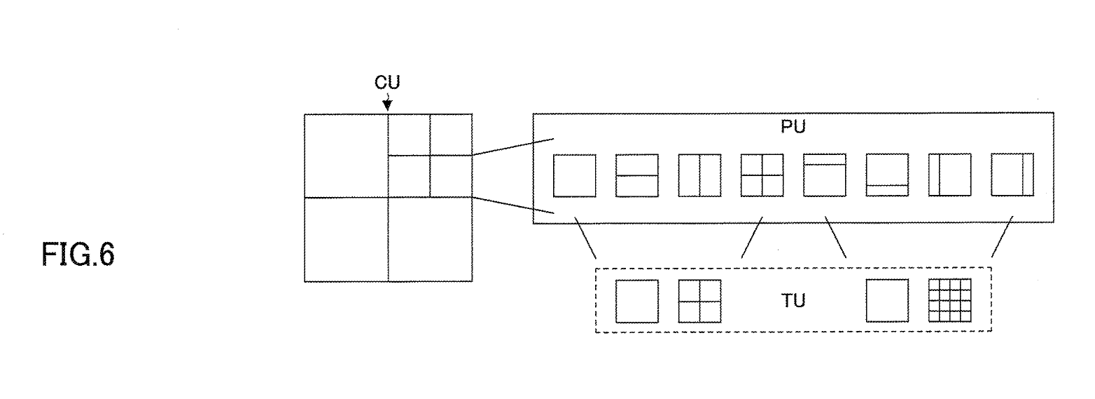

The prediction error signal generation section 101 acquires macro block data (hereinafter may be simplified as “block data”) which are generated by dividing the coding target image of input moving image data into blocks each having 16×16 pixels (hereinafter may be referred to as “macro blocks” (MBs)). In the first embodiment, the macro block division is described. However, a division unit as illustrated in FIG. 6 may also be applicable.

The prediction error signal generation section 101 generates a prediction error signal based on the above macro block data, the macro block data of a prediction image picture output from the prediction image selection section 114. The prediction error signal generation section 101 outputs the generated prediction error signal to the orthogonal transformation section 102.

The orthogonal transformation section 102 performs an orthogonal transformation process on the input prediction error signal. The orthogonal transformation section 102 outputs a signal to the quantization section 103. The signal includes components in both horizontal and vertical directions which have been separated in the orthogonal transformation process.

The quantization section 103 quantizes the output signal from the orthogonal transformation section 102. Due to the quantization, the quantization section 103 reduces the code amount of the output signal. The quantization section 103 outputs the (quantized) output signal to the entropy coding section 104, and the inverse quantization section 105.

The entropy coding section 104 performs entropy coding on the output signal from the quantization section 103, and outputs the (entropy coded) output signal. Here, the entropy coding refers to the allocation of the codes having variable length depending on appearance frequency of symbols.

The inverse quantization section 105 performs inverse quantization on the output signal from the quantization section 103, and outputs the (inverse-quantized) output signal to the inverse orthogonal transformation section 106.

The inverse orthogonal transformation section 106 performs inverse orthogonal transformation on the output signal from the inverse quantization section 105, and outputs the (inverse-orthogonal transformed) output signal to the decoded image generation section 107. By performing the decoding process by the inverse quantization section 105 and the inverse orthogonal transformation section 106, it may become possible to acquire a signal similar to the prediction error signal before being coded.

The decoded image generation section 107 adds the block data of an image, which have been motion-compensated by the inter prediction image generation section 111, to the prediction error signal which has been decoded by the inverse quantization section 105 and the inverse orthogonal transformation section 106. The decoded image generation section 107 outputs the block data of the decoded image generated by the addition to the deblocking filter section 108.

The deblocking filter section 108 performs filtering for reducing the block distortion on the decoded image output from the decoded image generation section 107, and outputs the (filtered) decoded image (block data) to the picture memory 109.

The picture memory 109 stores the input block data as new reference image data, and outputs the (new reference image) data to the intra prediction image generation section 110, the inter prediction image generation section 111, and the motion vector calculation section 112. The picture memory 109 further stores, for example, the motion vector of the blocks of the coded image and the division mode.

The intra prediction image generation section 110 generates a prediction image based on the already coded surrounding pixels of the coding target image.

The inter prediction image generation section 111 performs motion compensation on the reference image data, which are acquired from the picture memory 109, based on the motion vector provided from the motion vector calculation section 112. By doing this, the block data as the motion-compensated reference image may be generated.

The motion vector calculation section 112 acquires the motion vector based on the block data in the coding target image and the block data of the reference image of the coded image acquired from the picture memory 109. Here, the motion vector refers to a value indicating spatial displacement per block acquired using a block matching technique in which a position, which is in the reference image per block, most similar to the coding target image is located. The motion vector calculation section 112 outputs the acquired motion vector to the inter prediction image generation section 111.

The block data output from the intra prediction image generation section 110 and the inter prediction image generation section 111 are input to the prediction image selection section 114. The prediction image selection section 114 selects either one of the prediction images. The selected block data are output to the prediction error signal generation section 101.

Further, the coding control and header generation section 113 performs total control on the coding and header generation. The coding control and header generation section 113 sends a report to the intra prediction image generation section 110 whether slice division is applied, sends a report to the deblocking filter section 108 whether the deblocking filter is included, and sends a report to the motion vector calculation section 112 on the limitation of the reference image and the like.

The coding control and header generation section 113 generates, for example, H.264 header information based on the control result. The generated header information is transferred to the entropy coding section 104, and output as stream data along with the image data and the motion vector data.

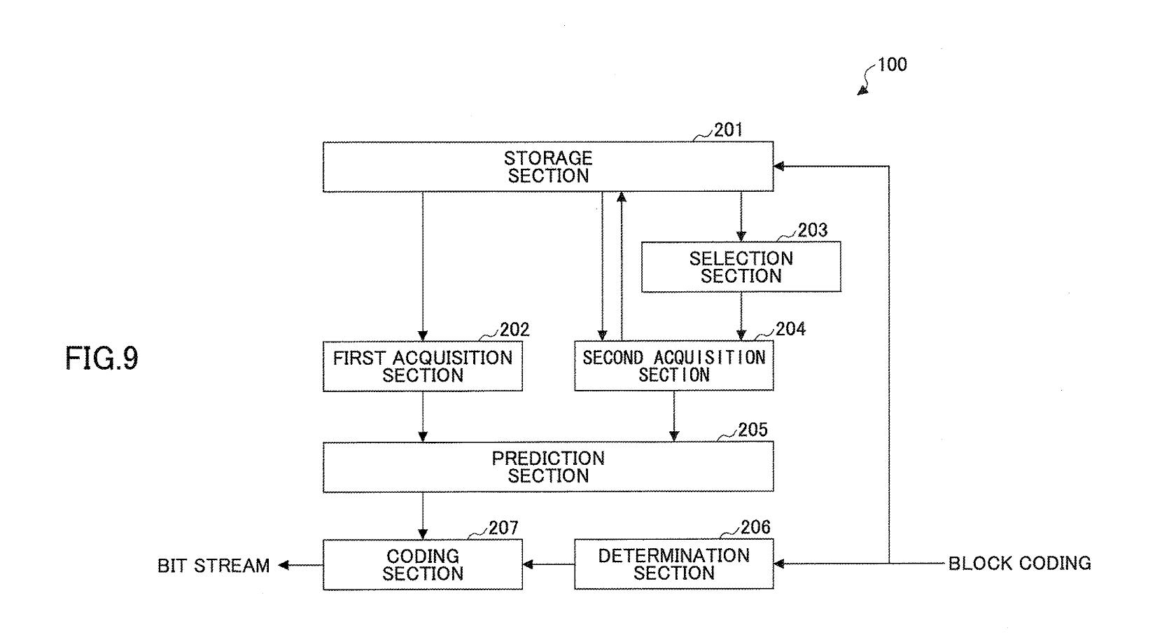

Next, a function on the prediction of the division mode is described. FIG. 9 is a block diagram of an example function on the prediction of the division mode in this embodiment. As illustrated in FIG. 9, the image coding device 100 includes a storage section 201, a first acquisition section 202, a selection section 203, a second acquisition section 204, a prediction section 205, a determination section 206, and a coding section 207.

The storage section 201 corresponds to the picture memory 109. The first acquisition section 202, the selection section 203, the second acquisition section 204, the prediction section 205, the determination section 206 correspond to the entropy coding section 104.

The storage section 201 stores the decoded image, which is generated by locally decoding the coded image, and coding information such as motion vectors per block section, a block type, and the division mode. The past coding information may be referred to in the coding target block which is to be coded next.

The first acquisition section 202 acquires coded coding information of the block belonging to the coding target image from the storage section 201. The block coding is typically started from the left upper side in the raster scanning order. Therefore, the coding information indicates all the left side on the same block line and all the above blocks of the coding target block as the already coded regions in the coding target image.

The first acquisition section 202 designates the block position of the coding target image based on a predetermined method, and acquires the coding information indicating such as already coded division mode and the motion vector belonging to the coding target image. The predetermined method is a method in which the blocks from among the upper blocks, left blocks, left upper blocks, and right upper blocks are selected in advance.

The selection section 203 selects a coded image from among plural coded images using the predetermined method to acquire the division mode of the coded image other than the coding target images stored in the storage section 201. The storage section 201 may attach unique indexes to the decoded images of the coded images and store as a list. The selection section 203 may indicate the selection result by using the coded image indexes.

The second acquisition section 204 acquires the coding information of the block belonging to the coded image selected by the selection section 203 from the storage section 201. Further, the second acquisition section 204 designates a block position based on a predetermined method, and acquires, from the storage section 201, the coding information of the block belonging to the coded image having the index selected by the selection section 203.

The prediction section 205 calculates a prediction mode which is a prediction value of the division mode of the coding target block based on coding information acquired from the first acquisition section 202 and the second acquisition section 204.

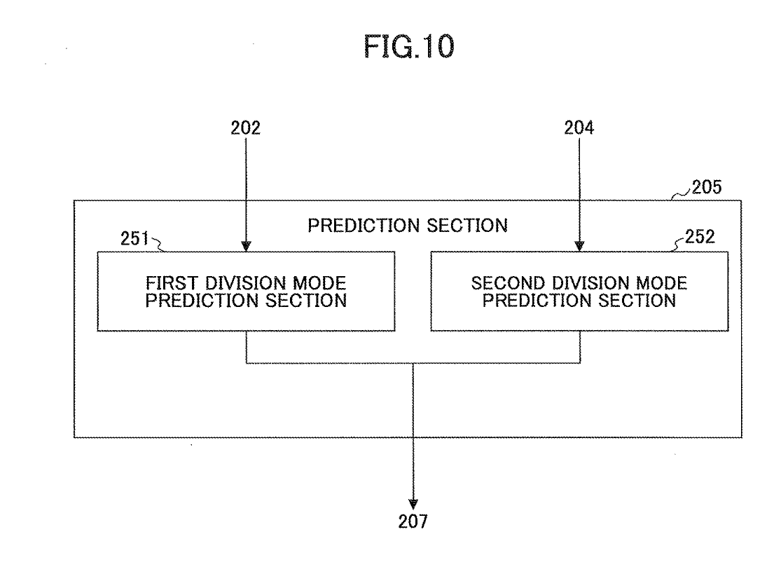

FIG. 10 is a block diagram illustrating an example function of the prediction section 205 according to the first embodiment. As illustrated in FIG. 10, the prediction section 205 includes a first division mode prediction section 251 and a second division mode prediction section 252.

The first division mode prediction section 251 calculates a candidate mode of the division mode based on the coding information acquired from the first acquisition section 202. The second division mode prediction section 252 calculates a candidate mode of the division mode based on the coding information acquired from the second acquisition section 204. The prediction section 205 determines the prediction mode from those candidate modes based on predetermined criteria.

Returning to FIG. 9, the determination section 206 determines the division mode to be used for the coding target block. The determination section 206 determines the division mode so as to refer to the most similar region by using, for example, block matching in the coding target block and plural reference images.

The coding section 207 generates division mode information indicating the division mode based on the prediction mode acquired from the prediction section 205 and the division mode determined by the determination section 206. The generated division mode information is included into the bit stream and transmitted.

As described above, by using the first acquisition section 202 and the second acquisition section 204, the division mode of the coded block in the spatial direction and the division mode of the coded block in the temporal direction may be acquired. In the image coding device 100 according to the first embodiment, by predicting the prediction mode by using those division modes, the prediction accuracy of division mode may be improved and the coding efficiency may also be improved.

### Second Embodiment

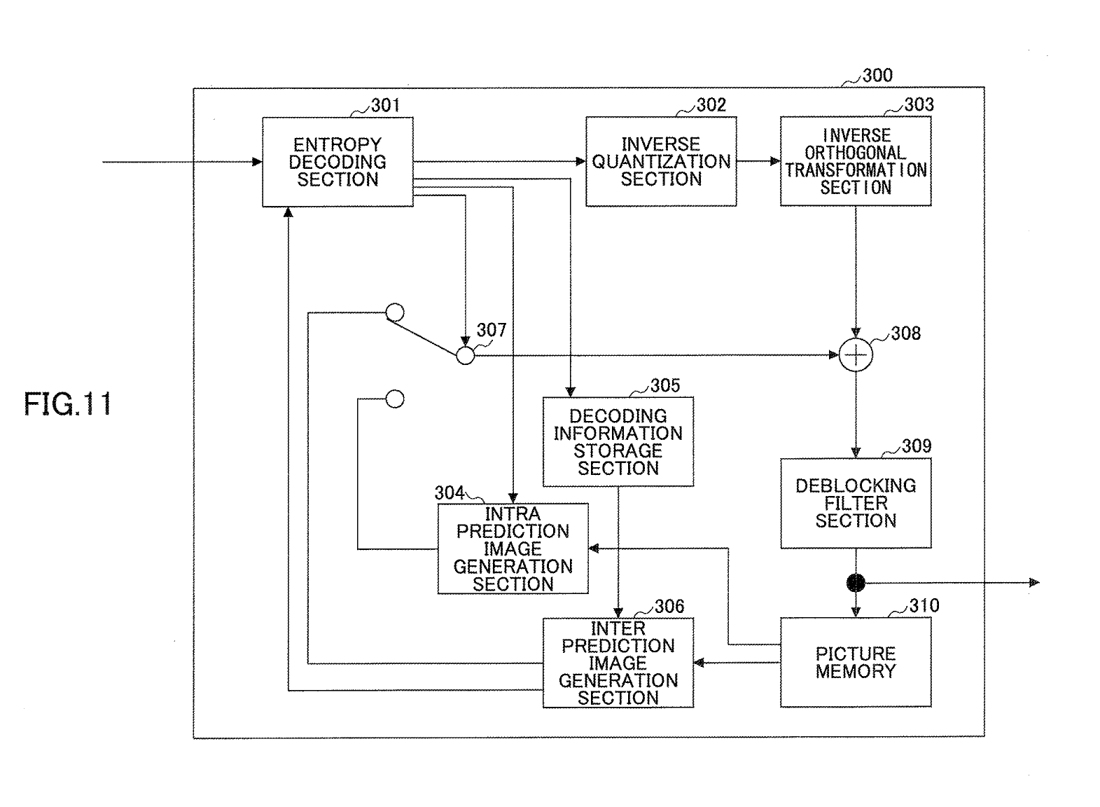

FIG. 11 is a block diagram of an example configuration of an image decoding device 300 according to a second embodiment. The image decoding device 300 in the second embodiment decodes the coded data that are coded by the image coding device 100 according to the first embodiment.

As illustrated in FIG. 11, the image decoding device 300 includes an entropy decoding section 301, an inverse quantization section 302, an inverse orthogonal transformation section 303, an intra prediction image generation section 304, a decoding information storage section 305, an inter prediction image generation section 306, a prediction image selection section 307, a decoded image generation section 308, a deblocking filter section 309, and a picture memory 310. Those elements are briefly described below.

Upon inputting a bit stream, the entropy decoding section 301 performs an entropy decoding process, which corresponds to the entropy coding process of the image coding device 100, on the input bit stream. The prediction error signal or the like that are decoded by the entropy decoding section 301 is output to the inverse quantization section 302. Further, when the inter prediction is performed, decoded motion vector and the like is output to the decoding information storage section 305.

When the intra prediction is performed, the information indicating that the intra prediction is performed is reported to the intra prediction image generation section 304. Further, the entropy decoding section 301 reports the information whether the inter prediction is performed on the decoding target image and whether the intra prediction is performed on the decoding target image to the prediction image selection section 307.

The inverse quantization section 302 performs the inverse quantization process on the output signal from the entropy decoding section 301. The inverse-quantized output signal is output to the inverse orthogonal transformation section 303.

The inverse orthogonal transformation section 303 performs the inverse orthogonal transformation process on the output signal from the inverse quantization section 302 to generate a residual signal. The residual signal is output to the decoded image generation section 308.

The intra prediction image generation section 304 sequentially generates prediction images, starting from the surrounding decoded pixels in the decoding target image.

The decoding information storage section 305 stores the decoding information including decoded motion vector and the division mode and the like.

The inter prediction image generation section 306 performs motion compensation on the data of the reference image, which is acquired from the picture memory 310, based on the motion vector and the division information acquired from the decoding information storage section 305. By doing this, the block data as the motion-compensated reference image may be generated.

The prediction image selection section 307 select either the intra prediction image or the inter prediction image as the prediction image. The selected block data are output to the decoded image generation section 308.

The decoded image generation section 308 adds the prediction image, which is output from the prediction image selection section 307, to the residual signal, which is output from the inverse orthogonal transformation section 303, to generate the decoded image. The generated decoded image is output to the deblocking filter section 309.

The deblocking filter section 309 performs a filtering process on the decoded image output from the decoded image generation section 308 to reduce the block distortion, and outputs the filtered output signal to the picture memory 310. The filtered decoded image may be output to the display device.

The picture memory 310 stores, for example, the decoded image serving as the reference image. Herein, the decoding information storage section 305 and the picture memory 310 are described as different elements. However, those elements may be integrated into the same storage section (a single element).

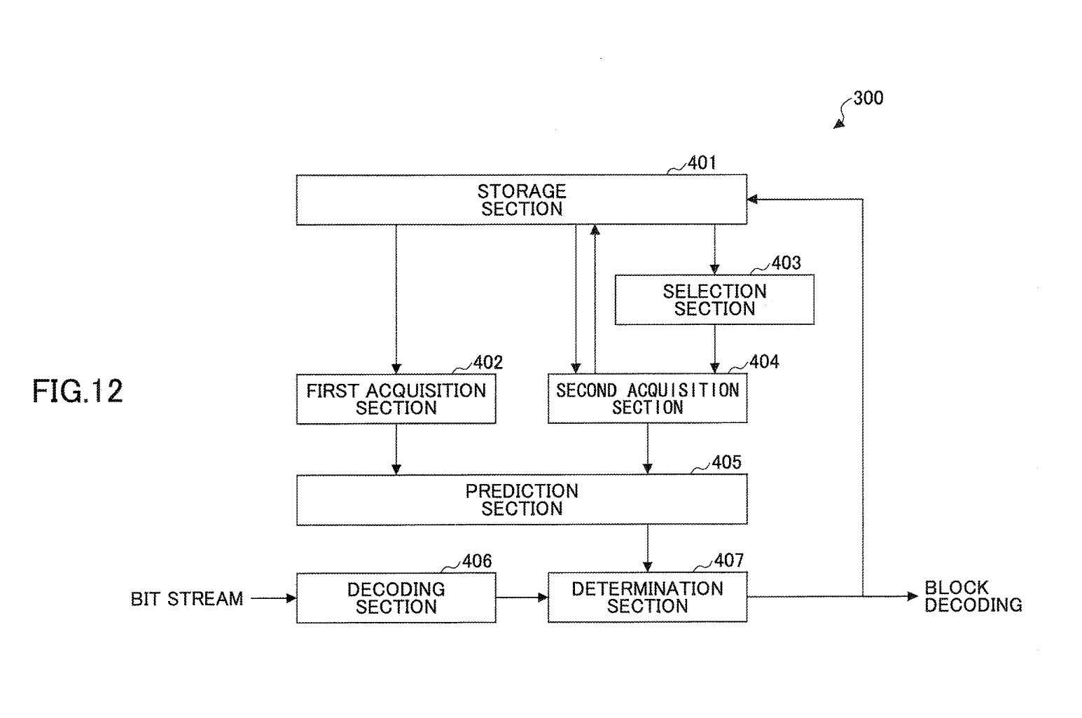

Next, a function of predicting the division mode is described. FIG. 12 is a block diagram illustrating an example function of predicting the division mode according to the second embodiment. In the example of FIG. 12, the image decoding device 300 includes a storage section 401, a first acquisition section 402, a selection section 403, a second acquisition section 404, a prediction section 405, a decoding section 406, and a determination section 407.

The image decoding device 300 of FIG. 12 decodes the bit stream output from the image coding device 100, and calculates the division mode of the decoding target block. Further, the elements of the image decoding device 300 correspond to the storage section 201, the first acquisition section 202, the selection section 203, the second acquisition section 204, the prediction section 205, the coding section 207, and the determination section 206.

Further, the storage section 401 corresponds to the decoding information storage section 305 and the picture memory 310. The first acquisition section 402, the selection section 403, the second acquisition section 404, and the prediction section 405 correspond to, for example, the inter prediction image generation section 306. The decoding section 406 and the determination section 407 correspond to, for example, the entropy decoding section 301.

The storage section 401 stores the decoded images in the past and decoding information including motion vector, the block type, the division mode for each of the blocks.

The first acquisition section 402 acquires the decoded decoding information belonging to the decoding target image from the storage section 401. The block decoding is normally started from the left upper corner of the decoding target image in the raster scanning order. Therefore, the decoded decoding information in the decoding target image corresponds to the left side of the same block line as that of the decoding target block and all the blocks located on the upper side of the decoding target block.

The selection section 403 selects the decoded image using a predetermined method to acquire the decoding information from plural decoded images other than the decoding target image stored in the storage section 401.

The second acquisition section 404 acquires the decoding information of the block belonging to the decoded image selected by the selection section 403.

The prediction section 405 calculates the prediction mode, which is the prediction value of the division mode of the decoding target block, based on the decoding information acquired from the first acquisition section 402 and the second acquisition section 404.

The decoding section 406 decodes the bit stream, and acquires the division mode information indicating the division mode.

The determination section 407 determines the division mode based on the prediction mode, which is acquired from the prediction section 405, and the division mode information acquired from the decoding section 406. The determined division mode is output to and stored in the storage section 401.

As described above, by using the first acquisition section 402 and the second acquisition section 404, the division mode of the decoded block in the spatial direction and the division mode of the decoded block in the temporal direction may be acquired. In the image decoding device 300 according to the second embodiment, by using those division modes it may become possible to correspond to the coding in which the prediction accuracy of the division mode is improved and also improve the decoding efficiency.

### Third Embodiment

Next, an image coding device according to a third embodiment is described. The configuration of the image coding device in the third embodiment is the same as that in FIG. 8. Here, the functions of predicting the division mode in the image coding device in the third embodiment is described by using the same reference numerals as those of the functions in FIGS. 9 and 10.

Further, in the third embodiment, an example of application with respect to the HEVC proposing method is described. In this example, the Coding Unit (CU), which may correspond to the micro block in related art, is segmentalized. Specifically, the CU is divided into partitions called Prediction Units (PUs) as a unit of prediction. The CU is also divided into partitions called Transform Units (TUs) as a unit of orthogonal transformation.

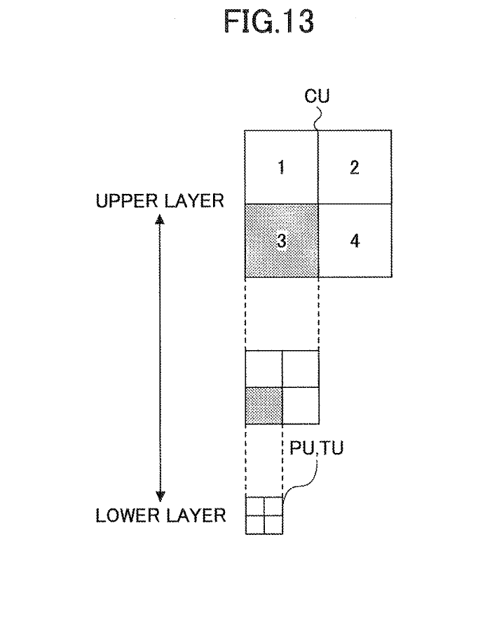

First, a CU block structure is sequentially scanned. The scanning may be performed by dividing into blocks using Quad tree, or based on raster scanning order. FIG. 13 schematically illustrates the hierarchy structure of the Quad tree. As illustrated in FIG. 13, when Quad tree is used, the CU may be hierarchized, and the bottom layer corresponds to the PU or TU.

In coding of the CU, if the coding target CU is divided, the hierarchy of the division is determined in the order from the left upper block 1 to the right bottom block 4. Namely, after determining the bottom layer, the hierarchies of the block 2, block 3, and the block 4 are determined.

Therefore, the coded region where coding target division block may be referred to becomes the coded division block of the coded other CU and the coding target CU. Here, it is preferable that as the coded information which is referred to when a certain division block is coded, the coded information corresponding to the same or lower hierarchy is used. The division mode when the CU and the TU are coded is division capable flag (split coding unit flag, split transform unit flag). For example, the division capable flag is “1” when divided and “0” when not divided.

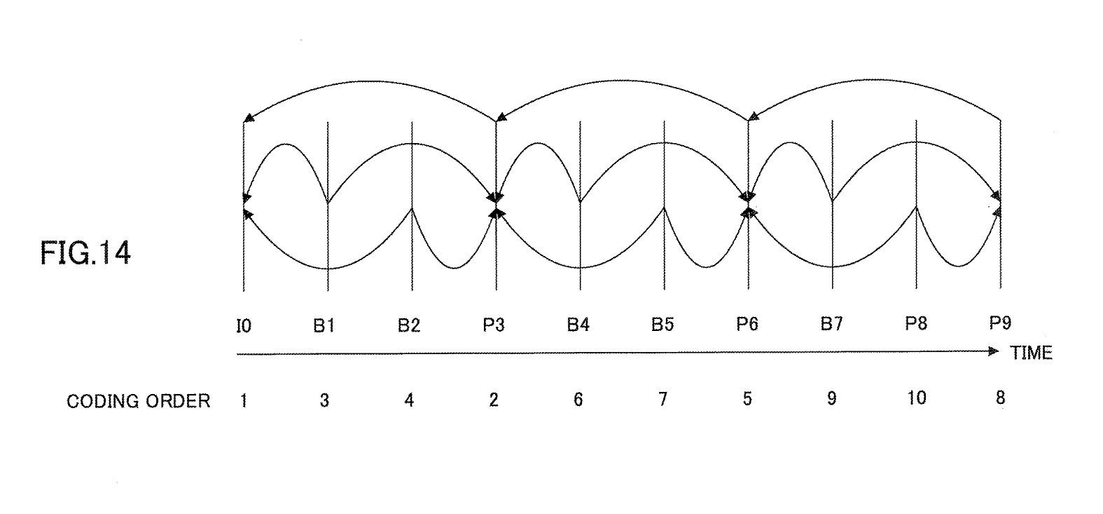

Next, the data structure used in the third embodiment is described. FIG. 14 illustrates an example of the GOP structure (IBBP structure) in the third embodiment. In the following, the IBBP structure is described as the example. The symbols “I”, “P”, and “B” denote the picture types, and the number next to the picture type corresponds to the time order. Here, the coding is performed in the order of I0, P3, B1, B2, P6, B4, B5, P9, B7, and P8. The arrows in FIG. 14 denote a forward or backward vector.

In the third embodiment, a case is described where B4 picture of FIG. 14 is coded. The process described below may be similarly applied to other P pictures and B pictures. When coding B4 picture, P3 picture and P6 picture are already coded, so that P4 picture may refer to P3 picture and P6 picture as coded images.

The storage section 201 stores the coding information of the coded images. Specifically, the storage section 201 stores the coding information indicating, for example, the motion vector, the block type, the division mode and the like of the P3 picture and the P6 picture.

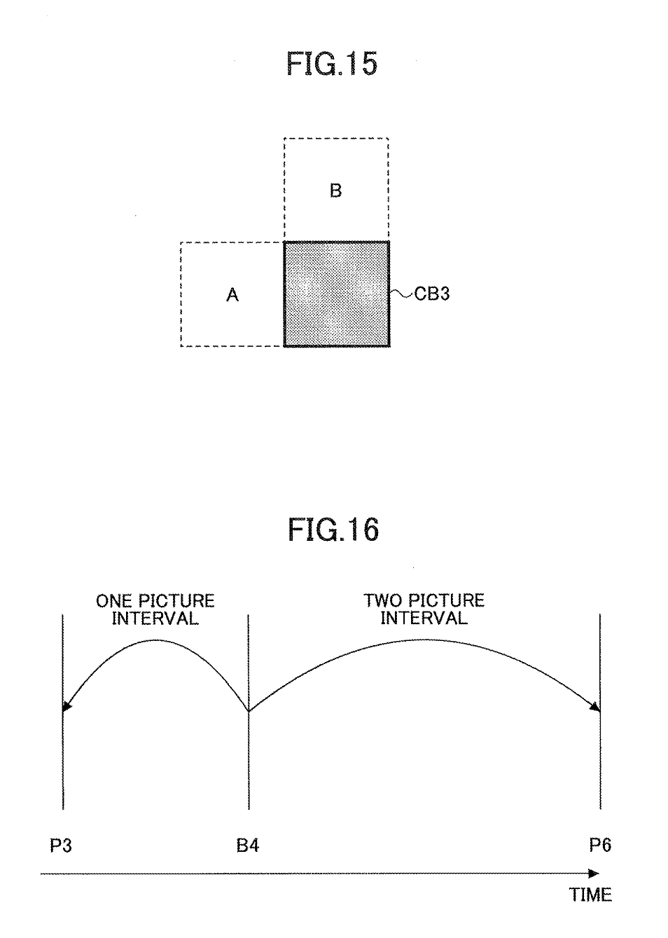

The first acquisition section 202 acquires the division mode of the coded block belonging to the coding target image from the storage section 201. FIG. 15 illustrates an example relationship between the coding target block and the surrounding blocks.

As illustrated in FIG. 15, the first acquisition section 202 acquires the division modes A and B of the block A, which is on the left side of the coding target block CB3, and the block B, which is on the upper side of the coding target block CB3. The blocks A and B are surrounding blocks of the coding target block CB3.

Here, the division modes of the blocks A and B are division modes A and B, respectively. Further, the first acquisition section 202 may acquire the division mode information of the blocks which are on the left upper side and the right upper side of the coding target block CB3. Further, in a coding method such as H.264 in which the division type is defined as the block type, the first acquisition section 202 may acquire the block type.

The selection section 203 selects a predetermined coded image. Here, B4 picture may refer to P3 picture and P6 picture. Preferably, for example, the selection section 203 selects the coded image having the shortest time interval between the coding target image and the coded image. This is because the smaller the time interval between the coding target image and the coded image becomes, the higher the reliability of the prediction becomes.

FIG. 16 illustrates the time interval (distance) between the coding target image and the reference image. As illustrated in FIG. 16, the distance between B4 picture and P6 picture is 2 picture distance. The distance between B4 picture and P3 picture is one picture distance. In this case, the selection section 203 selects P3 picture having smaller picture distance.

The second acquisition section 204 acquires the coding information of the block belonging to the coded image selected by the selection section 203, from the storage section 201. Here, it may be preferable that the second acquisition section 204 determines which block in the selected coded image is to be acquired as the coding information in advance.

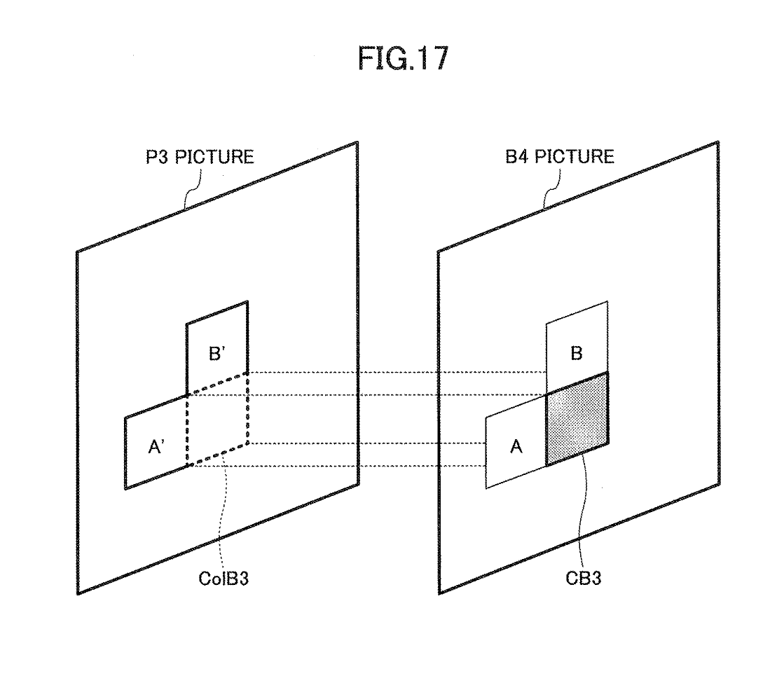

FIG. 17 illustrates the block to be acquired by the second acquisition section 204. For example, as illustrated in FIG. 17, the second acquisition section 204 acquires the division mode X of the block ColB3 (Collocated block X) which is located in the same position as that in the coding target block CB3 in P3 picture.

Further, the second acquisition section 204 acquires the division modes A′ and B′ of the block A′ and the block B′ which are located on the left and upper sides, respectively, of the Collocated block ColB3 that is located in the same position as that of the block whose division mode is acquired by the first acquisition section 202.

The prediction section 205 calculates the prediction mode which is the prediction value of the division mode of the coding target block based on the coding information acquired from the first acquisition section 202 and the second acquisition section 204. As described with reference to FIG. 10, the prediction section 205 includes the first division mode prediction section 251 and the second division mode prediction section 252.

The first division mode prediction section 251 sets the division modes A and B, in B4 picture, acquired by the first acquisition section 202 to candidate modes A and B, respectively.

The second division mode prediction section 252 sets the division mode X acquired from the second acquisition section 204 to a candidate mode X. The second division mode prediction section 252 sets the division modes A′ and B′ to candidate modes A′ and B′, respectively.

The prediction section 205 calculates the prediction mode which is the prediction value of the division mode of the coding target block based on the candidate modes acquired from the first division mode prediction section 251 and the second division mode prediction section 252.

For example, the prediction section 205 compares division modes, which corresponding to the same position, acquired from the first acquisition section 202 and the second acquisition section 204.

The prediction section 205 determines (compares) whether the candidate mode A acquired from the first division mode prediction section 251 corresponds to the candidate mode A′ acquired from the second division mode prediction section 252.

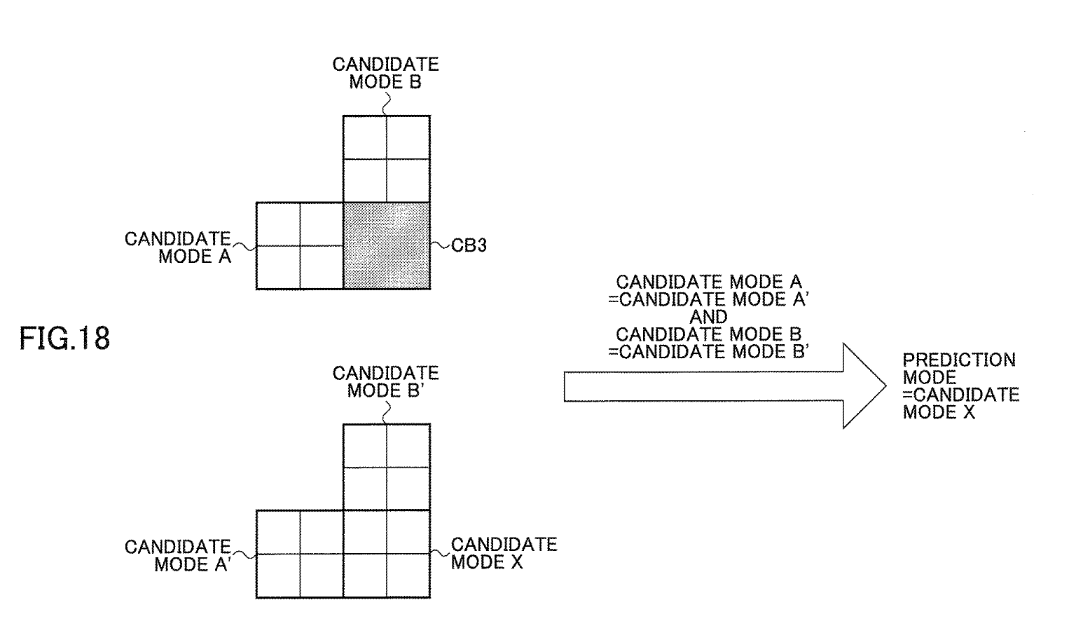

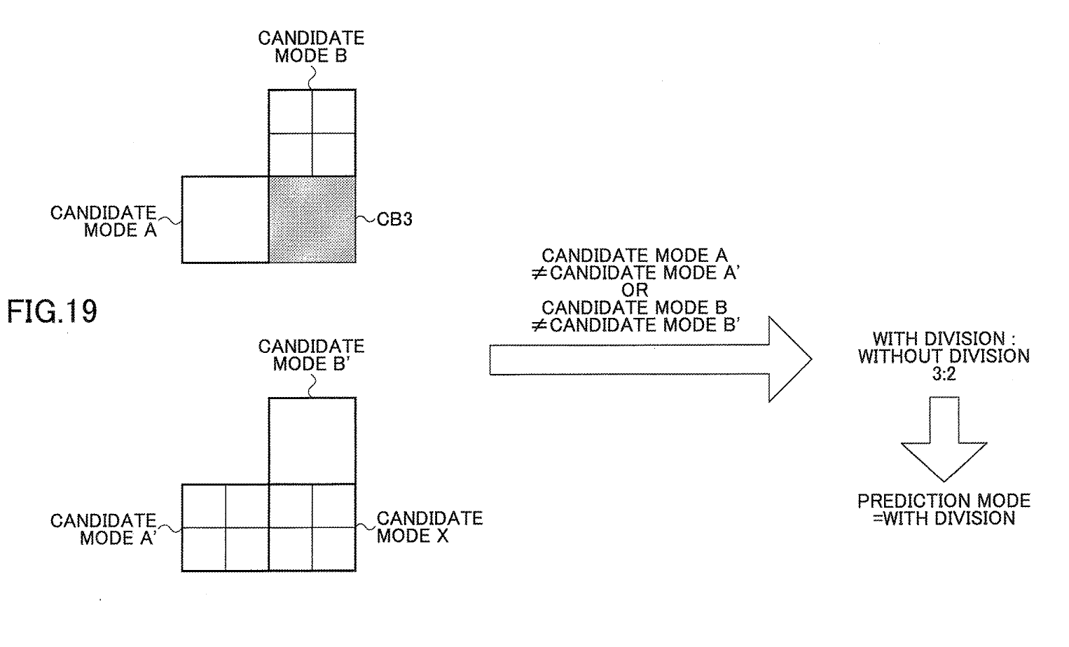

Further, the prediction section 205 determines (compares) whether the candidate mode B acquired from the first division mode prediction section 251 corresponds to the candidate mode B′ acquired from the second division mode prediction section 252. The comparisons are described below with reference to FIGS. 18 and 19.

FIG. 18 illustrates a first comparison by the prediction section 205. As illustrated in FIG. 18, when corresponded results are acquired in the comparisons by the prediction section 205, the prediction section 205 sets the candidate mode X acquired by the second division mode prediction section 252 as the prediction mode. This is because if the division mode of the surrounding blocks corresponds to each other, there may be high probability that the division mode X of the coding target block CB3 corresponds to that of the Collocated block.

FIG. 19 illustrates a second comparison by the prediction section 205. As illustrated in FIG. 19, when a different result at least one of the comparisons by the prediction section 205, the prediction section 205 sets (selects) the candidate mode, which is most frequently present among the candidate modes A, B, A′, B′, and X, as the prediction mode.

This is because it is not always the case that the division mode X of the coding target block CB3 corresponds to that of the Collocated block. Further, for example, if the division mode with division is most present, the division mode with division may be set as the prediction mode.

The determination section 206 performs block matching between the coding target block and plural reference images, and determines the division mode so as to select most similar regions. The evaluation value of the block matching may be determined based on the sum of the absolute value of the differences between pixels or the sum of the square of the difference between pixels.

The coding section 207 calculates a flag (inconsistency flag) indicating whether the prediction mode predicted by the prediction section 205 corresponds to the division mode determined by the determination section 206. When it is determined that the prediction mode corresponds to the division mode, the coding section 207 sets the inconsistency flag to “0”. When it is determined that the prediction mode does not corresponds to the division mode, the coding section 207 sets the inconsistency flag to “1”. The coding section 207 includes the inconsistency flag into the bit stream by performing arithmetic coding on the inconsistency flag.

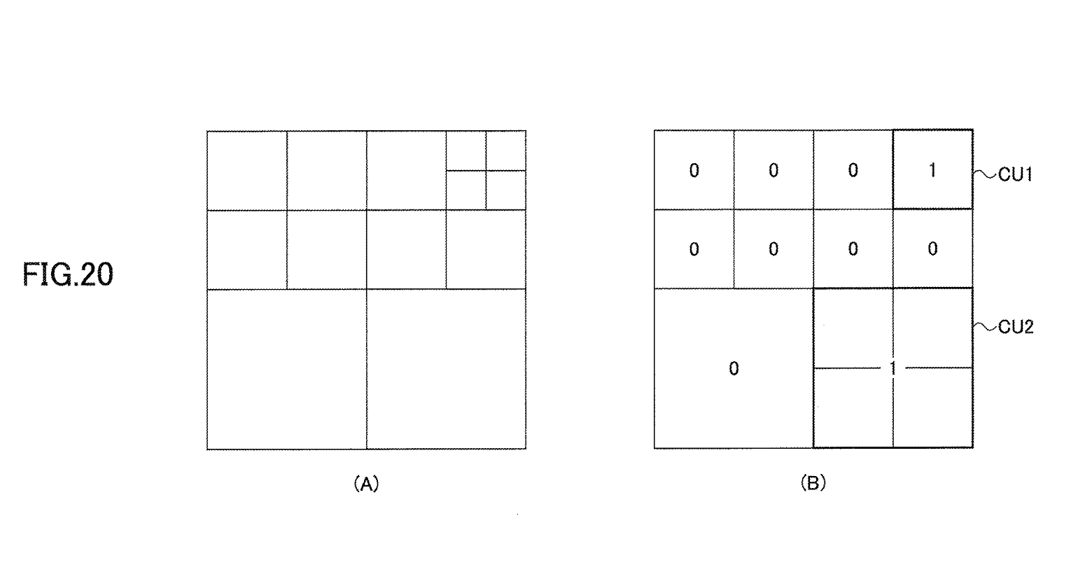

FIG. 20 illustrates an example inconsistency flag. A part (A) of FIG. 20 illustrates a division state of the prediction mode of the coding target CU. A part (B) of FIG. 20 illustrates the actual division state of the coding target CU and the values of the inconsistency flag.

For example, as illustrated in FIG. 20, the coding section 207 set the value of the inconsistency flag to “0” when the block division of the coding target CU corresponds to the prediction mode, and sets the value to “1” when the block division of the coding target CU differs from to the prediction mode.

The CU1 in part (B) of FIG. 20 is indicated as the block with division in the prediction mode (see part (A) of FIG. 20), but actually is not divided. Therefore, the inconsistency flag thereof is set to “1”.

The CU2 in part (B) of FIG. 20 is indicated as the block without division in the prediction mode (see part (A) of FIG. 20), but actually is divided. Therefore, the inconsistency flag thereof is set to “1”.

There may be time correlation in a coding structure. Therefore, the reporting bit of the inconsistency flag is likely to be biased to “0” in terms of probability when the prediction is correct. When the probability is biased, the coding amount may be reduced to one bit or less by using the arithmetic coding.

When the coding structure differs, from the corresponding layer, a normal coding method may be used. In case of Quad tree block division, when no block division, a value “0” is reported. When block division is performed, a value “1” is reported.

By doing this, it may become possible to reduce the coding amount when the prediction mode predicted in spatial and temporal directions correspond to the actual division mode.

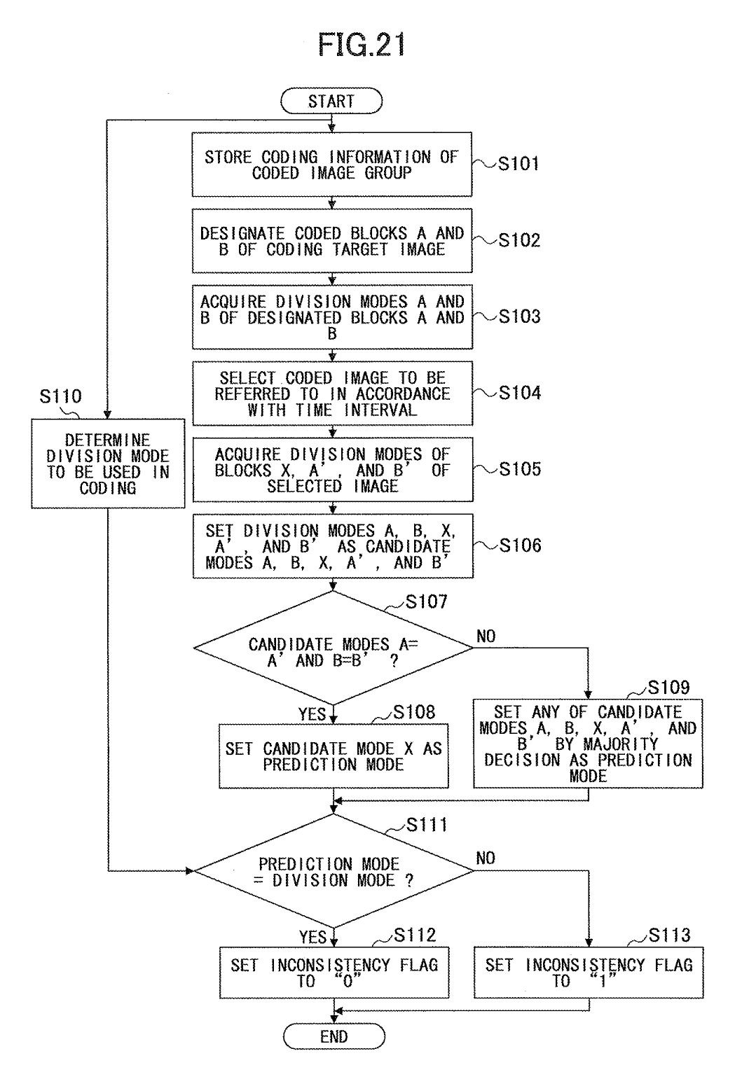

Next, the operations of the image coding device according to the third embodiment are described. FIG. 21 is a flowchart of an example division mode coding process according to the third embodiment.

As illustrated in FIG. 21, in step S101, the storage section 201 stores the coding information including the motion vector, the block type, and the division mode per block of the coded image.

In steps S102 and S103, the first acquisition section 202 acquires the division mode, which is included in the coding information of the coded block belonging to the coding target image, from the storage section 201.

In the example of FIG. 15, the first acquisition section 202 acquires the division modes A and B of the blocks A and B, respectively. The block A is located next to and on the left side of the coding target block, and the block B is located next to and on the upper side of the coding target block.

In step S104, the selection section 203 selects the coded image having the shortest time interval to the coding target image from among the reference images related to the coding target image.

In step S105, the second acquisition section 204 acquires the division modes X, A′ and B′ belonging to the Collocates block A, the block A′, which is located next to and on the left side of the Collocates block A, and the block B′, respectively, which is located next to and on the upper side of the Collocates block A, in the coded image (selected image) selected by the selection section 203.

In step S106, the first division mode prediction section 251 the sets the division modes A and B to the candidate modes A and B, respectively, and the second division mode prediction section 252 sets the sets the division modes X, A′, and B to the candidate modes X, A′, and B, respectively.

In step S107, the prediction section 205 determines whether the candidate mode A corresponds to the candidate mode A′ and also determines whether the candidate mode B corresponds to the candidate mode B′. When it is determined that the candidate mode A corresponds to the candidate mode A′ and the candidate mode B corresponds to the candidate mode B′ (YES in step S107), the process goes to step S108. When it is determined that the candidate mode A does not correspond to the candidate mode A′ or the candidate mode B does not correspond to the candidate mode B′ (NO in step S107), the process goes to step S109.

In step S108, the prediction section 205 sets the candidate mode X as the prediction mode.

In step S109, when the number of candidate modes with division is greater than the number of the candidate modes without division among the candidate modes A, B, X, A′, and B′, the prediction section 205 sets the information indicating “with division” to the prediction mode.

On the other hand, when the number of candidate modes with division is less than the number of the candidate modes without division among the candidate modes A, B, X, A′, and B′, the prediction section 205 sets the information indicating “without division” to the prediction mode.

In step S110, the determination section 206 determines the division mode of the coding target block by performing the block matching.

In step S111, the coding section 207 determines whether the prediction mode corresponds to the division mode. When it is determined that the prediction mode corresponds to the division mode (YES in step S111), the process goes to step S112, otherwise (NO in step S111), the process goes to step S113.

In step S112, the coding section 207 sets the value of the inconsistency flag to “0” as the division mode information.

In step S113, the coding section 207 sets the value of the inconsistency flag to “1” as the division mode information.

As described above, in the third embodiment, it may become possible to acquire the division block of the coded block spatially close to the coding target block. Also it may become possible to acquire the division mode of the coded block located on the same position as that in the coding target block close to the coded block in the temporal direction, and also acquire the division modes of the coded blocks located on the surrounding positions of as those surrounding the coding target block close to the coded blocks in the temporal direction.

By doing this, it may become possible to improve the prediction accuracy of the division mode of the coding target block. This is based on that if the division mode of the coding target block is the same as that of the block, which is close to the coding target block in spatial direction, in the temporal direction, there is high possibility that the division mode of the coding target block is the same as that of the block in the same position, in temporal direction, as that of the coding target block, the coding target block being close to the block in the spatial direction. Therefore, when the prediction accuracy of the division mode is increased, the value of the inconsistency flag may be biased. As a result, it may become possible to improve the coding efficiency.

### Fourth Embodiment

Next, an image decoding device according to a fourth embodiment is described. The configuration of the image decoding device in the fourth embodiment is the same as that illustrated in FIG. 11. The same reference numerals are used to describe the same functions of predicting in the image decoding device in the fourth embodiment as those described in FIG. 11.

Further, the image decoding device in the fourth embodiment decodes the bit stream that is coded by the image coding device in the third embodiment.

The storage section 401 stores decoded image decoded in the past, and the decoding information including the motion vector, the block type, and the division mode per block and the like.

The first acquisition section 402 acquires the division mode, which is included in the decoding information of the decoded block belonging to the decoding target image, from the storage section 401. Here, the division mode A of the block, which is next to and on the right side of the decoding target block, and the division mode B of the block, which is next to and on the upper side of the decoding target block, are acquired.

The selection section 403 selects a predetermined decoded image from among the plural decoded images other than the decoding target image stored in the storage section 401. For example, the selection section 403 selects the reference image having the shortest time interval between the reference image (decoded image) and the decoding target image.

The second acquisition section 404 acquires the decoding information of the decoded Collocated block, which is selected by the selection section 403, the block A, and the block B. The block A is located next to and on the left side of the Collocated block, and the block B is located next to and on the upper side of the Collocated block. The second acquisition section 404 sets the acquired decoding information of the decoded Collocated block, the block A, and the block B as the division modes X, A′, and B′, respectively.

The prediction section 405 calculates the prediction mode which is the prediction value of the division mode of the decoding target block based on the division modes A and B, which are acquired from the first acquisition section 402, and the division modes X, A′, and B′ which are acquired from the second acquisition section 404.

For example, the prediction section 405 determines (compares) whether the candidate mode A corresponds to the candidate mode A′ and further determines (compares) whether the candidate mode B corresponds to the candidate mode B′.

When it is determined that candidate mode A corresponds to the candidate mode A′ and the candidate mode B corresponds to the candidate mode B′, the prediction section 405 sets the division mode A as the prediction mode.

On the other hand, when it is determined that the candidate mode A does not corresponds to the candidate mode A′ or the candidate mode B does not corresponds to the candidate mode B′, the prediction section 405 determines whether information indicating “with division” or “without division” by majority decision.

The decoding section 406 decodes the bit stream, and acquires the division mode information indicating the division mode. In this case, as the division mode information, the inconsistency flag is acquired.

For example, the vale of the inconsistency flag is “0” when it is determined that candidate mode A corresponds to the candidate mode A′ and the candidate mode B corresponds to the candidate mode B′.

Further, the vale of the inconsistency flag is “1” when it is determined that the candidate mode A does not corresponds to the candidate mode A′ or the candidate mode B does not corresponds to the candidate mode B′.

When the value of the inconsistency flag is “0”, the determination section 407 sets (determines) the prediction mode acquired from the prediction section 405 as the division mode.

When the value of the inconsistency flag is “1”, the determination section 407 sets (determines) a mode other than prediction mode as the division mode. The determined division mode is output to the storage section 401, and the storage section 401 stores the determined division mode.

By doing this, the bit stream, which is generated by the image coding device described in the third embodiment, may be decoded.

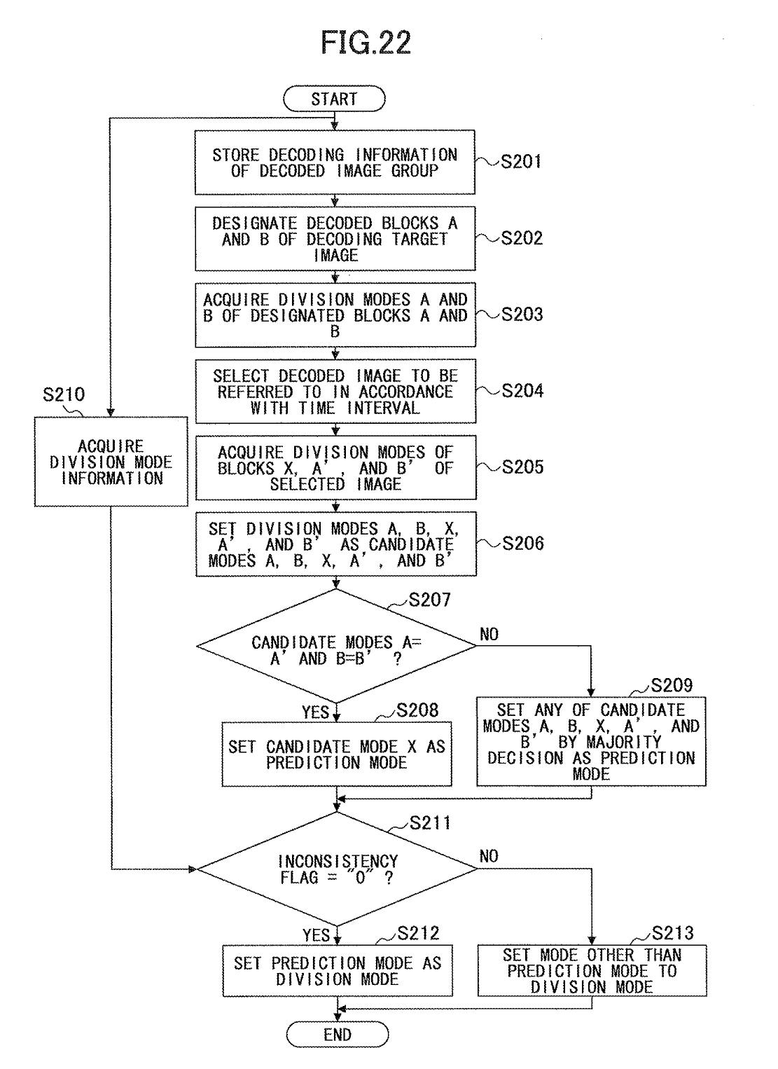

Next, an example operation of the image decoding device according to the fourth embodiment is described. FIG. 22 is a flowchart illustrating an example division mode decoding process according to the fourth embodiment.

As illustrated in FIG. 22, in step S201, the storage section 401 stores the decoding information including the motion vector, the block type, and the division mode per block in the decoded images and the like.

In steps S202 and S203, the first acquisition section 402 acquires the division mode included in the decoding information of the decoded block belonging to the decoding target image.

In the example of FIG. 15, the first acquisition section 402 acquires the division modes A and B of the blocks A and the block B. The block A is located next to and on the left side of the decoding target block, and the block B is located next to and on the upper side of the decoding target block.

In step S204, the selection section 403 selects the encoded image having the short time interval from the decoding target image from among the reference images related to the decoding target image.

In step S205, the second acquisition section 404 acquires the division modes X, A′, and B′ belonging to the Collocated block X, the block A′ and the block B′ in the decoded image selected by the selection section 403. Here, the block A′ is located next to and on the left side of the decoding target block X, and the block B′ is located next to and on the upper side of the decoding target block X.

In step S206, the prediction section 405 sets the division modes A and B as the candidate modes A and B, and further sets the division modes X, A′, and B′ as the candidate modes X, A′, and B′, respectively.

In step S207, the prediction section 405 determines whether the candidate mode A corresponds to the candidate mode A′ and the candidate mode B corresponds to the candidate mode B′. When it is determined that the candidate mode A corresponds to the candidate mode A′ and the candidate mode B corresponds to the candidate mode B′ (YES in step S207), the process goes to step S208. Otherwise (NO in step S207), the process goes to step S209.

In step S208, the prediction section 405 sets the candidate mode X as the prediction mode.

In step S209, when the number of candidate modes with division is greater than the number of the candidate modes without division among the candidate modes A, B, X, A′, and B′, the prediction section 405 sets the information indicating “with division” to the prediction mode.

On the other hand, when the number of candidate modes with division is less than the number of the candidate modes without division among the candidate modes A, B, X, A′, and B′, the prediction section 405 sets the information indicating “without division” to the prediction mode.

In step S210, the decoding section 406 decodes the bit stream (coded data), and acquires the division mode information.

In step S211, the determination section 407 determines whether the value of the inconsistency flag, which indicates the division mode information, is “0”. When it is determined that the value of the inconsistency flag is “0” (YES in step S211), the process goes to step S212. When it is determined that the value of the inconsistency flag is “1” (NO in step S211), the process goes to step S213.

In step S212, the determination section 407 determines the division mode which is indicated by the prediction mode. In step S213, the determination section 407 determines a division mode other than the prediction mode.

As described above, in the fourth embodiment, it may become possible to acquire the division mode of the coded block having shorter distance in spatial direction. Also, it may become possible to acquire the division modes of the decoded blocks corresponding to the coded blocks in the same and surrounding positions with those in the decoding target blocks having a short time interval from the coded blocks.

By doing this, it may become possible to improve the prediction accuracy of the division mode and determine the division mode of the decoding target block with higher prediction accuracy.

Next, an image coding device according to a fifth embodiment is described. In H.264 division mode coding, there are various forms of division modes as block types are coded. In the Prediction Unit (PU) which is the division mode of the partition as the prediction unit of the HEVC proposed method, the block type is coded, which is similar to the macro block type of the H.264. Therefore, in the fifth embodiment, an example of application of the block type is described.

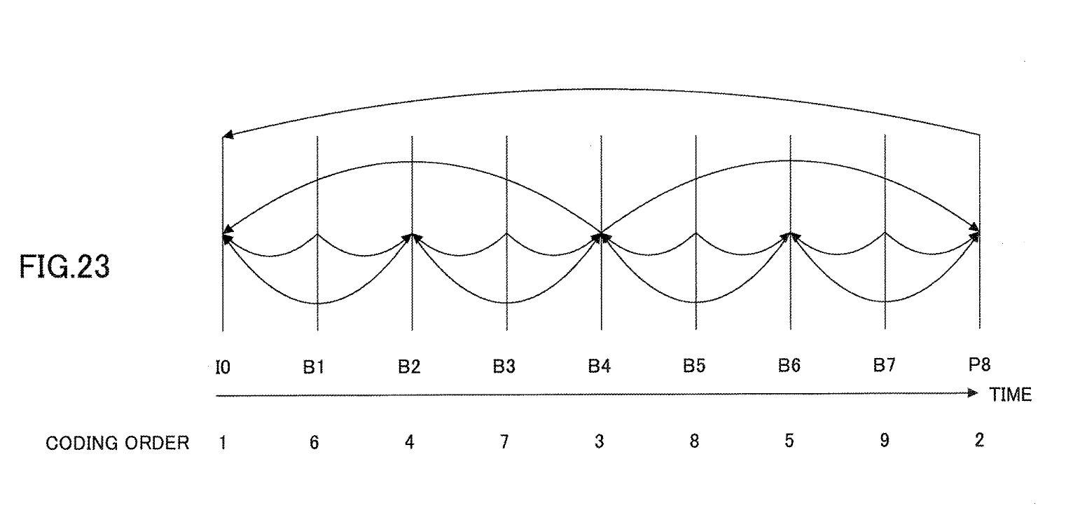

FIG. 23 illustrates an example of the GOP structure (B structure) in the fifth embodiment. In the following, the B structure is described as the example. The symbols “I”, “P”, and “B” denote the picture types, and the number next to the picture type corresponds to the time order. Here, the coding is performed in the order of I0, P8, B4, B2, B6, B1, B3, B5, and B7. The arrows in FIG. 23 denote a forward or backward vector.

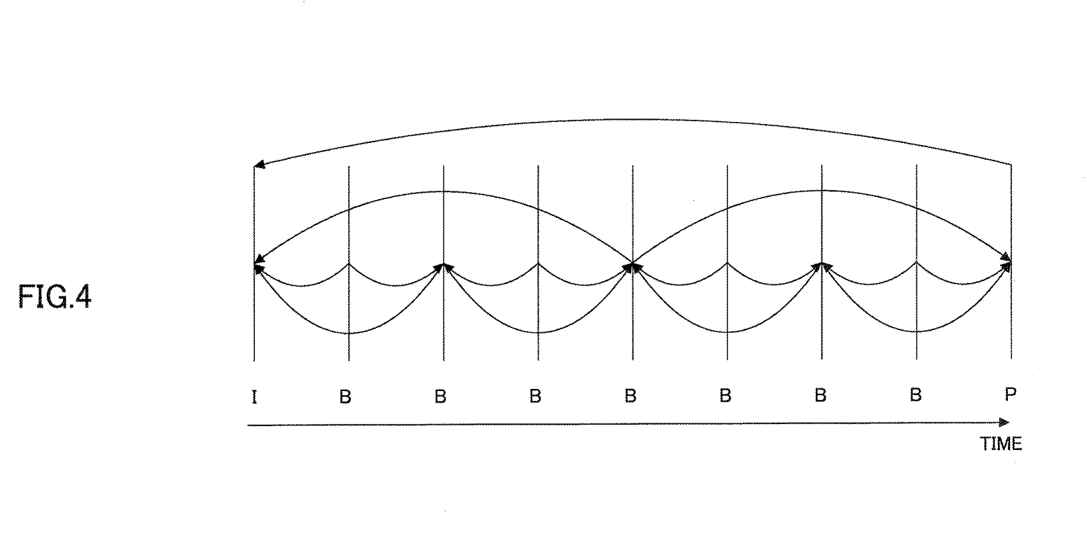

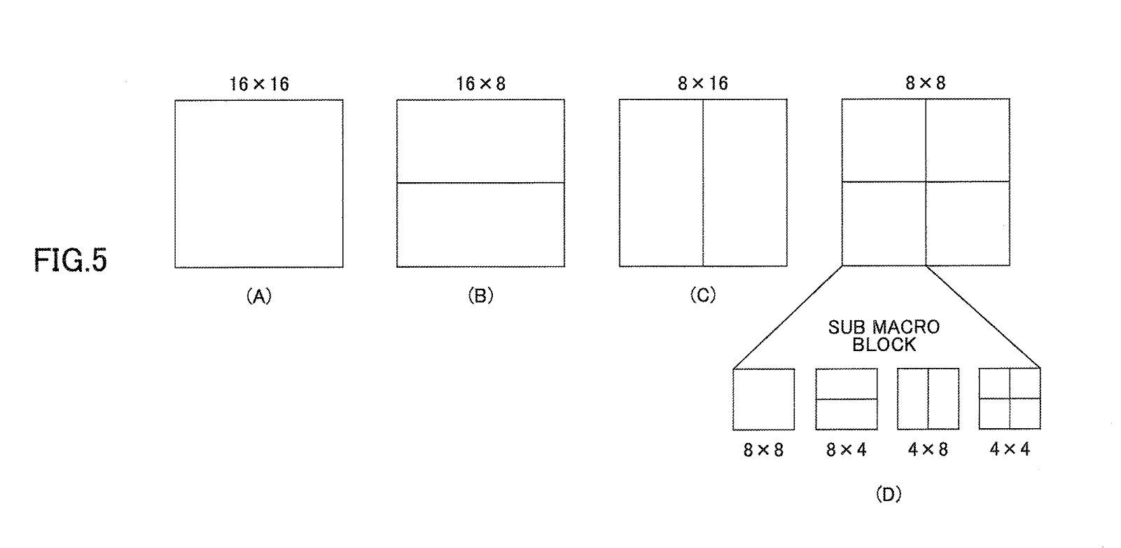

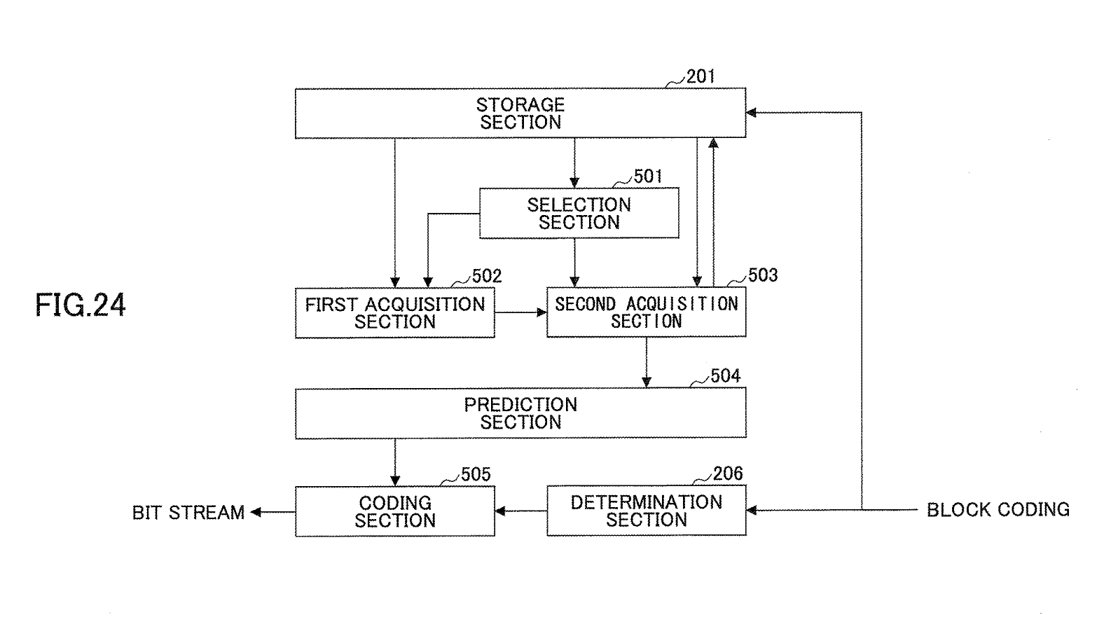

The configuration of the image coding device in the fifth embodiment is similar to that of FIG. 4. Therefore, the same reference numerals are used to describe the same elements. The function of predicting the division mode in the fifth embodiment is illustrated in FIG. 24. FIG. 24 is a block diagram illustrating an example prediction function of the division mode according to the fifth embodiment.

The image coding device according to the fifth embodiment includes a storage section 201, a selection section 501, a first acquisition section 502, a second acquisition section 503, a prediction section 504, a determination section 206, and a coding section 505. In FIG. 24, the same reference numerals as those in FIG. 9 are used to describe the same functions.

In the fifth embodiment, a prediction method of the division mode is described by assuming that B5 picture of FIG. 23 is the coding target image. However, the prediction method of the division mode according to the fifth embodiment may also be applied to other P and B pictures. The storage section 201 in this embodiment is same as that in the third embodiment.

For example, the selection section 501 selects the coded image having the shortest time interval between the coded image and the coding target image. This is because the shorter the time interval between the coded image and the coding target image becomes, the higher the prediction reliability becomes.

As illustrated in FIG. 23, the time interval between B5 picture and B4 picture and the time interval between B5 picture and B6 picture are one picture and the same as each other. Under this condition, when one picture is to be selected, selection section 501 selects the coded image having the shortest time interval between the coded image and the coding target image. This is because the shorter the time interval between the coded image and the coding target image becomes, the higher the prediction reliability becomes.

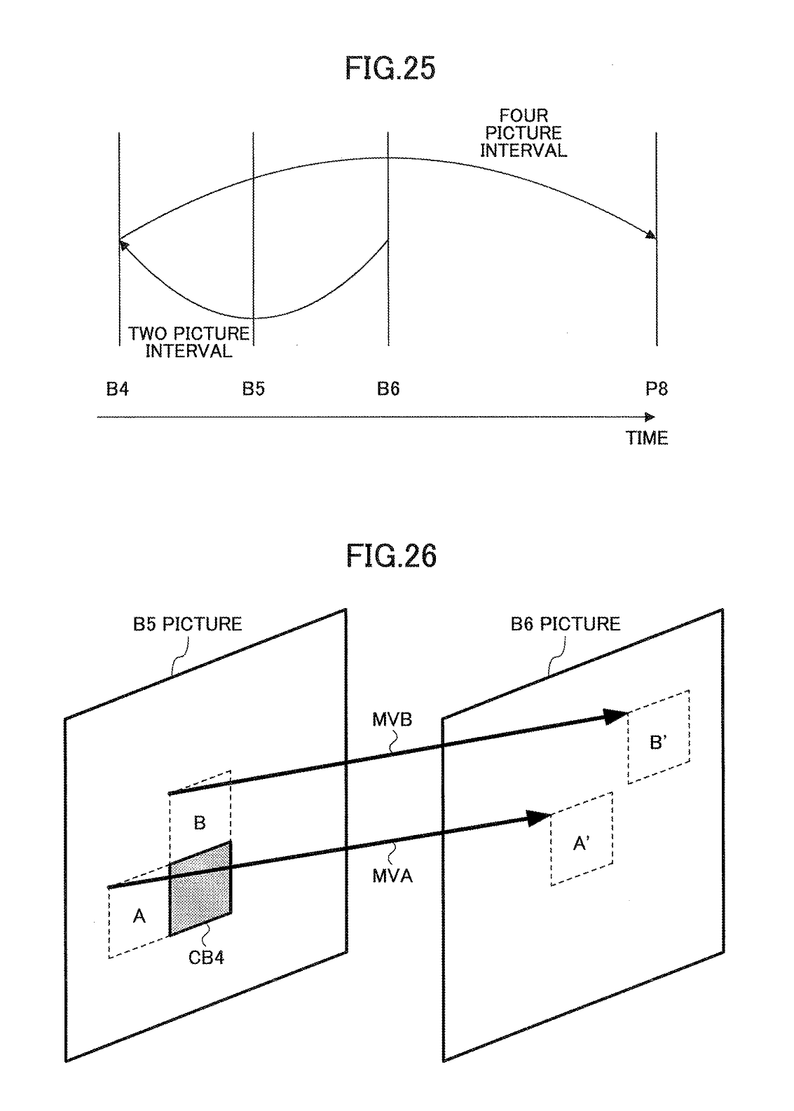

FIG. 25 illustrates an example of picture intervals. As illustrated in FIG. 25, B4 picture refers to P8 picture, and B6 picture refers to B4 picture. Further, B5 picture is located between B4 picture and P8 picture and between B4 picture and B6 picture.

Namely, the coding target image is located between the coded image and the reference image of the coded image. The picture interval between B4 picture and P8 picture is four picture intervals, and the picture interval between B4 picture and B6 picture is two pictures intervals. Therefore, B6 picture is selected by the selection section 501. The selection section 501 reports the information of the selected picture to the first acquisition section 502 and the second acquisition section 503.

The first acquisition section 502 acquires the coding information of the coded block belonging to the coding target image from the storage section 201. FIG. 26 illustrates example coding information acquired by the first acquisition section 502. As illustrated in FIG. 26, the first acquisition section 502 acquires motion vectors A and B corresponding to the blocks A and B, respectively. The block A is located next to and on the left side of the coding target block CB4, and the block B is located next to and on the upper side of the coding target block CB4.

Here, the motion vector A refers to the motion vector relative to the block A, and the motion vector B refers to the motion vector relative to the block B. The first acquisition section 502 acquires the motion vector relative to the picture reported from the selection section 501. In this case, the motion vector relative to B6 picture is acquired.

When there is no motion vector relative to B6 picture but there exists a motion vector relative to P8 picture in the same direction, the first acquisition section 502 appropriately performs temporal direction scaling, and calculates the motion vector relative to B6 picture.

In this case, the scale of the motion vector relative to the B6 picture is one third of that of the motion vector relative to P8 picture. The first acquisition section 502 outputs the acquired motion vector to the second acquisition section 503. Further, if the block, whose motion vector is to be acquired, is intra coded, the first acquisition section 502 deems the motion vector invalid.

The second acquisition section 503 acquires the coding information of the block belonging to the coded image, which is selected by the selection section 501, from the storage section 201. The second acquisition section 503 calculates a vector of the intermediate values, the average values or the like based on the plural motion vectors acquired from the first acquisition section 502. This vector is herein called a “tentative motion vector”.

Here, as an example of the tentative motion vector, a vector of the average values is calculated. Further, when all the motion vectors acquired from the first acquisition section 502 are invalid, the result (output) is zero vector.

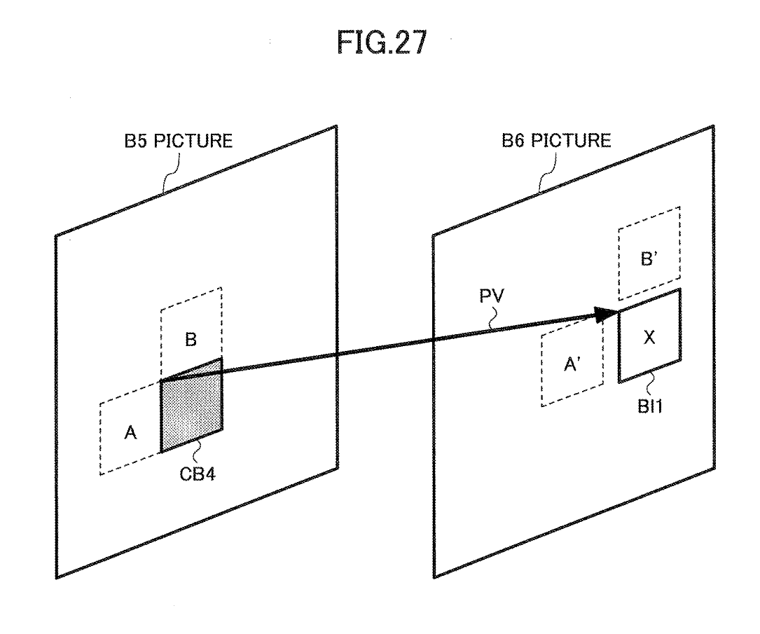

FIG. 27 illustrates an example tentative motion vector. As illustrated in FIG. 27, the second acquisition section 503 calculates the tentative motion vector based on the following formula:

Tentative vector=(motion vector A+motion vector B)/2

Based on this, the second acquisition section 503 estimates the destination coordinate equivalent to the coding target block to B6 picture by assuming the calculated average vector (pvx, pvy) as the estimation vector (tentative vector) PV of the coding target block. When assuming that the coordinate of coding target block CB4 is (x,y), the destination coordinate is (x+pvx, y+pvy).

The second acquisition section 503 acquires the division mode X of block B11 (block X) of B6 picture including the destination coordinate. Further, when the destination coordinate is out of the screen, the division mode of the block X may not be acquired.

Therefore, in this case, the selection section 501, the first acquisition section 502, the second acquisition section 503, and the prediction section 504 may perform the process described in the third embodiment. Further, if the block X is coded based on the intra prediction, the prediction section 504 sets the division mode X to invalid.

The prediction section 504 calculates the prediction mode, which is the prediction value of the division mode of the coding target block, based on the coding information acquired from the second acquisition section 503. For example, the prediction section 504 directly sets the division mode X, which is acquired from the second acquisition section 503, to the prediction mode X. The determination section 206 in this embodiment may perform the same operations as describe in the third embodiment.

The coding section 505 is described by referring to the division mode coding method in H.264 as an example.

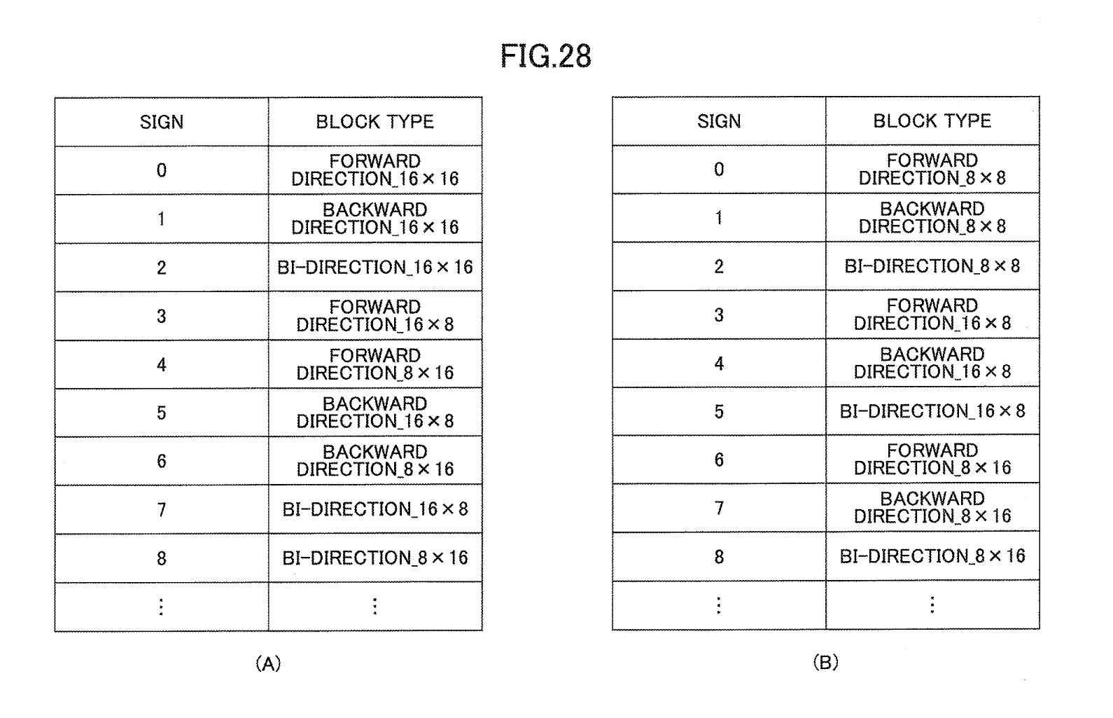

FIG. 28 illustrates an example coding table. The coding section 505 performs coding by treating the division mode and the reference mode indicating the reference direction (i.e., forward direction, backward direction, and bi-direction) which are illustrated in FIG. 28, as the block type.

Here, it is assumed that the smaller the value of the sign is, the smaller the code amount is. In H.264, as illustrated in a part (A) of FIG. 28, predetermined signs are sequentially allocated based on the division types. Therefore, it may be insufficient.

In fifth embodiment, the coding section 505 changes the contents of the coding table based on the prediction modes of the division modes. For example, the coding section 505 changes the contents of the coding table so as to reduce the code amount of the block including the prediction mode X.

For example, when the prediction mode is 8×8 division, the coding section 505 changes the order of the macro block type including the 8×8 division as illustrated in the part (B) of FIG. 28. Further, the coding section 505 changes the order in a manner that the rank of the divided block (e.g., 8×8, 8×16) is higher than that of the non-divided block (16×16). When the prediction mode X is invalid due to coding using intra prediction, the coding section 505 does not change the coding table.

By doing this, when the prediction mode corresponds to the actual division mode, it may become possible to perform coding using a code having a smaller value. Therefore, it may become possible to reduce the code amount related to the block type.

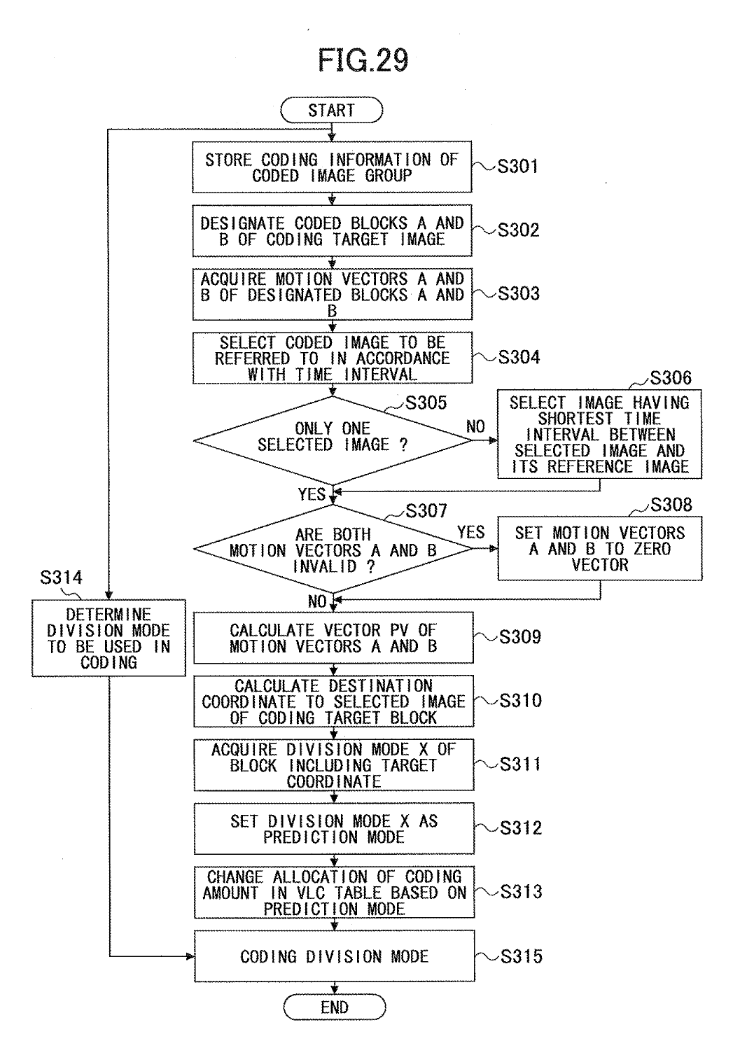

Next, an operation of the image coding device according to the fifth embodiment is described. FIG. 29 is a flowchart of an example coding process of the division mode according to the fifth embodiment.

As illustrated in FIG. 29, in step S301, the storage section 201 stores the coding information including the motion vector, block type, division mode and the like per each of the blocks of the coding target image.

In steps S302 and S303, the first acquisition section 502 acquires the motion vector included in the coding information of the coded block belonging to the coding target image. In the example of FIG. 26, the first acquisition section 502 acquires motion vectors A and B of the block A and block B. The block A is located next to and on the left side of the coding target block, and the block B is located next to and on the upper side of the coding target block.

In step S304, the selection section 501 selects the coded image (selected image) having a short time interval from the coding target image from among the reference images relative to the coding target image.

In step S305, the selection section 501 determines whether the number of the selected image is one. When it is determined that the number of the selected image is one (YES in step S305), the process goes to step S307. When it is determined that the number of the selected image is more than one (NO in step S305), the process goes to step S306.

In step S306, the selection section 501 selects the coded image having the shortest time interval between the selected image and its reference image.

In step S307, the second acquisition section 503 determines whether the motion vectors A and B, which are acquired from the first acquisition section 502, indicate the selected image selected by the selection section 501 or the reference image in the coding target image direction. If the motion vectors A and B do not indicate any of these images, it is determined that the vectors are invalid. Therefore, if it is determined that both vectors A and B are invalid, (YES in step S307), the process goes to step S308. When any of the vectors A and B is valid (NO in step S307), the process goes to step S309.

In step S308, the second acquisition section 503 sets the motion vectors A and B as zero vectors.

In step S309, the second acquisition section 503 calculates an average vector PV of the motion vectors A and B. When determining that the number of valid vectors is only one, the second acquisition section 503 averages the motion vector to be set as an estimation vector PV.

In step S310, the second acquisition section 503 calculates the destination coordinate to the selected image of the coding target block based on the estimation vector PV.

In step S311, the second acquisition section 503 acquires the division mode X of the block including the destination coordinate.

In step S312, the prediction section 504 sets the division mode X, which is acquired by the second acquisition section 503, as the prediction mode.

In step S313, the coding section 505 changes the allocation of the coding amount in the Variable Length Coding (VLC) table based on the prediction mode. For example, the coding section 505 changes the VLC table so that the value of the division mode of the prediction mode has a smaller sign.

In step S314, the determination section 206 determines the division mode of the coding target block using the block matching.

In step S315, the coding section 505 converts the division mode, which is determined by the determination section 206, into the sign based on the VLC table. The sign is set as the division mode information. The division mode information is included in the bit stream.

After step S310, the second acquisition section 503 may determine whether the destination coordinate is included in the screen. When it is determined that the destination coordinate is out of the screen, the prediction mode of the division mode may be set by performing the processes from step S103. Further, to make it simpler, when it is determined that the destination coordinate is out of the screen, the division mode X may be set to the division mode indicating the division.

As described above, according to the fifth embodiment, by locating (finding) the block similar to the coding target block in the temporal direction, it may become possible to improve the coding efficiency. This is based on the idea that there is high possibility that the division mode of the block similar to the coding target block is the same as that of the coding target block.

Therefore, when the prediction accuracy of the division mode is improved, the code amount of the code to be converted based on the VLC table may be reduced. As a result, it may become possible to improve the coding efficiency.

### Sixth Embodiment

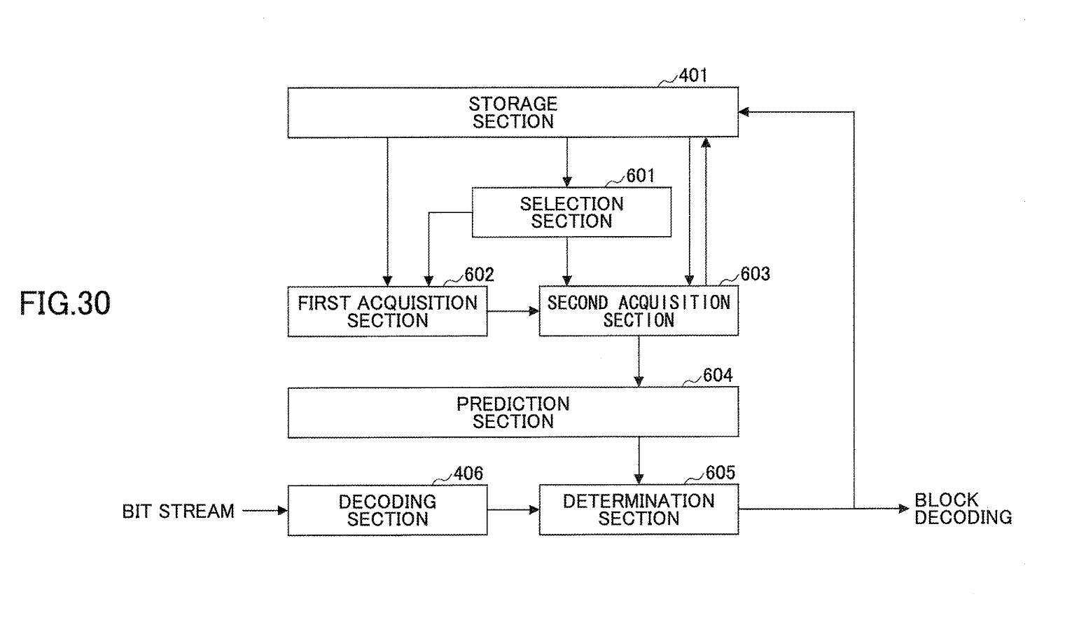

Next, an image decoding device according to a sixth embodiment is described. The configuration of the image decoding device according to the sixth embodiment is similar to that illustrated in FIG. 11. Further, the function of predicting the division mode in the sixth embodiment is described in FIG. 30. FIG. 30 is a block diagram of an example function of predicting the division mode according the sixth embodiment.

Further, the image decoding device according to the sixth embodiment decodes the bit stream which is coded by the image coding device according to the fifth embodiment.

The image decoding device according to the sixth embodiment includes the storage section 401, a selection section 601, a first acquisition section 602, a second acquisition section 603, a prediction section 604, a determination section 605, and the decoding section 406. Here, in FIG. 30, the same reference numerals are used as those in FIG. 12 to describe the same functions. The storage section 401 is similar to that in the fourth embodiment.

For example, the selection section 601 selects the decoded image having the shortest time distance between the decoded image and the decoding target image. When there are more than one selected images, the selection section 601 selects the decoded image having the shortest time distance between the decoded image and the reference image of the decoded image. The selection section 601 outputs the selected picture information to the first acquisition section 602, and the second acquisition section 603.

The first acquisition section 602 acquires the motion vector included in the decoding information of the decoded block belonging to the decoding target image. For example, the first acquisition section 602 acquires the motion vectors of the block A and the block B. The block A is located next to and on the left side of the decoding target block, and the block B is located next to and on the upper side of the decoding target block. The first acquisition section 602 acquires the motion vectors relative to the picture reported (output) from the selection section 601.

When determining that there is no motion vector relative to the selected picture but there is the motion vector to the picture located on the in the same direction as that of the selected picture, the first acquisition section 602 performs scaling in the temporal direction and calculates the motion vector relative to the selected picture. Further, if the block relative to the motion vector to be acquired is intra coded, the first acquisition section 602 sets the motion vector as invalid.

The second acquisition section 603 acquires the decoding information of the block belonging to the decoded image selected by the selection section 601. The second acquisition section 603 calculates a vector of the intermediate values, the average values or the like based on the plural motion vectors acquired from the first acquisition section 602.

This vector is herein called the tentative motion vector. Here, as an example of the tentative motion vector, a vector of the average values is calculated. Further, when all the motion vectors acquired from the first acquisition section 602 are invalid, the result (output) is a zero vector.

The second acquisition section 603 estimates the destination coordinate equivalent to the decoding target block to the selected decoded image by assuming the calculated average vector (pvx, pvy) as the estimation vector (tentative vector) PV of the decoding target block. When assuming that the coordinate of decoding target block CB4 is (x,y), the destination coordinate is (x+pvx, y+pvy).

The second acquisition section 603 acquires the division mode X of the block X of the decoded image including the destination coordinate. Further, when the destination coordinate is out of the screen, the division mode of the block X may not be acquired.

Therefore, in this case, the selection section 601, the first acquisition section 602, the second acquisition section 603, the prediction section 604 may perform the process described in the fourth embodiment. Further, if the block X is coded based on the intra prediction, the division mode X is set as invalid.

The prediction section 604 calculates the prediction mode, which is the prediction value of the division mode of the decoding target block, based on the decoding information acquired from the second acquisition section 603. For example, the prediction section 604 directly sets the division mode X, which is acquired from the second acquisition section 603, to the prediction mode X. The decoding section 406 in this embodiment may perform the same operations as describe in, for example, the fourth embodiment.

The determination section 605 sets a decoding table by using the acquired prediction modes as references. For example, the determination section 605 adequately changes the decoding table so that the block including the prediction mode X is ranked in higher rankings.

For example, when the prediction mode is 8×8 division, the determination section 605 changes the order of the macro block type including the 8×8 division so as to be ranked in a higher position. Further, the determination section 605 changes the order in a manner that the rank of the divided block (e.g., 8×8, 8×16) is higher than that of the non-divided block (16×16).

When the prediction mode X is invalid due to coding using intra prediction, the determination section 605 does not change the coding table. The determination section 605 determines the division mode based on the codes, which is indicated by the division mode, and the decoding table.

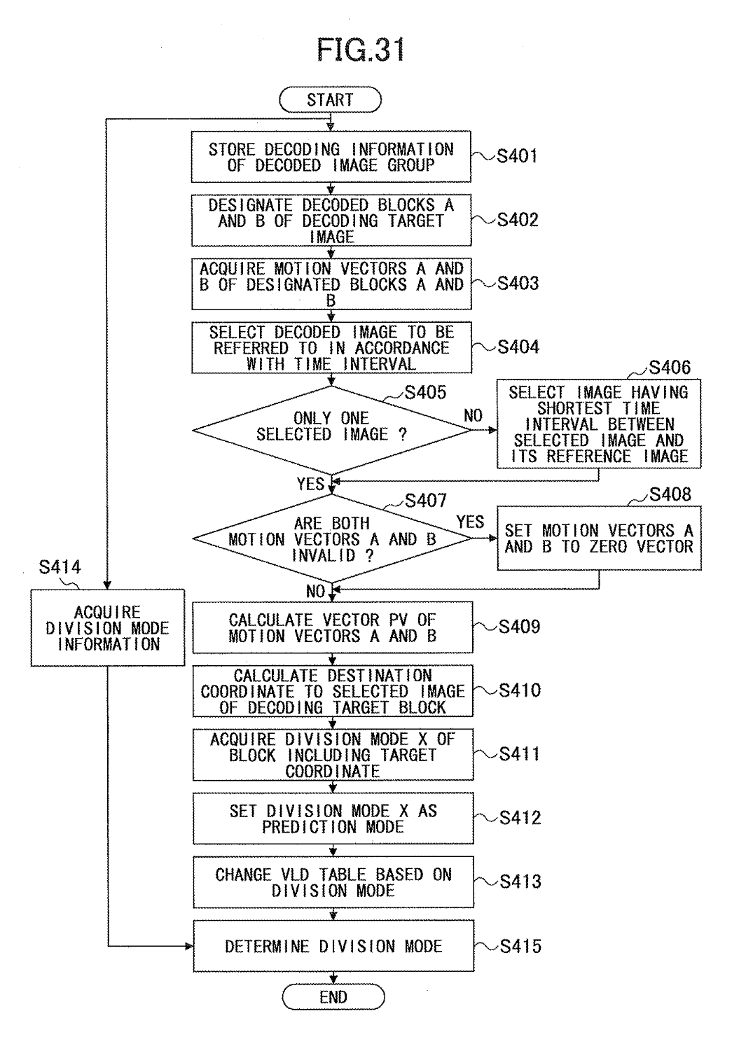

Next, an operation of the image decoding device according to the sixth embodiment is described. FIG. 31 is a flowchart of an example operation of the division mode decoding process in the sixth embodiment.

As illustrated in FIG. 31, in step S401, the storage section 401 stores the coding information including the motion vector, block type, division mode and the like per each of the blocks of the coding target image.

In steps S402 and S403, the first acquisition section 602 acquires the motion vector included in the decoding information of the decoded block belonging to the decoding target image. The first acquisition section 602 acquires the motion vectors A and B of the block A and block B. The block A is located next to and on the left side of the decoding target block, and the block B is located next to and on the upper side of the decoding target block.

In step S404, the selection section 601 selects the decoded image (selected image) having a short time interval from the decoding target image from among the reference images relative to the decoding target image.

In step S405, the selection section 601 determines whether the number of the selected image is one. When it is determined that the number of the selected image is one (YES in step S405), the process goes to step S407. When it is determined that the number of the selected image is more than one (NO in step S405), the process goes to step S406.

In step S406, the selection section 601 selects the decoded image having the shortest time interval between the selected image and its reference image.

In step S407, the second acquisition section 603 determines whether the motion vectors A and B, which are acquired from the first acquisition section 602, indicate the selected image selected by the selection section 601 or the reference image in the decoding target image direction. If the motion vectors A and B do not indicate any of these images, it is determined that the vectors are invalid. Therefore, if it is determined that both vectors A and B are invalid, (YES in step S407), the process goes to step S408. When any of the vectors A and B is valid (NO in step S407), the process goes to step S409.

In step S408, the second acquisition section 603 sets the motion vectors A and B as zero vectors.

In step S409, the second acquisition section 603 averages the motion vectors A and B, and calculates the estimation vector PV. When determining that the number of valid vectors is only one, the second acquisition section 603 treats the motion vector as the estimation vector PV.

In step S410, the second acquisition section 603 calculates the destination coordinate to the selected image of the decoding target block based on the estimation vector PV.

In step S411, the second acquisition section 603 acquires the division mode X of the block including the destination coordinate.

In step S412, the prediction section 604 sets the division mode X, which is acquired by the second acquisition section 603, as the prediction mode.

In step S413, the determination section 605 changes the Variable Length Decoding (VLD) table based on the prediction mode based on the prediction modes. For example, the determination section 605 changes the VLD table so that the division mode indicating the division shape of the prediction mode is ranged in a higher position.

In step S414, the decoding section 406 decodes the bit stream, and acquires the division mode information of the decoding target block.

In step S415, the determination section 605 converts the sign indicated by the division mode determined by the decoding section 406 into the division mode based on the VLD table. By doing this, the determination section 605 may determine the division mode.

Further, after step S410, the second acquisition section 603 may determine whether the destination coordinate is included in the screen. When it is determined that the destination coordinate is out of the screen, the prediction mode of the division mode may be determined by performing the processes from step S203. Further, to make it simpler, when it is determined that the destination coordinate is out of the screen, the second acquisition section 603 may set division mode X as the division mode indicating the division.

As described above, according to the sixth embodiment, the division mode of the decoding target block may be determined in response to the coding in which the prediction accuracy of the division mode is improved according to the fifth embodiment.

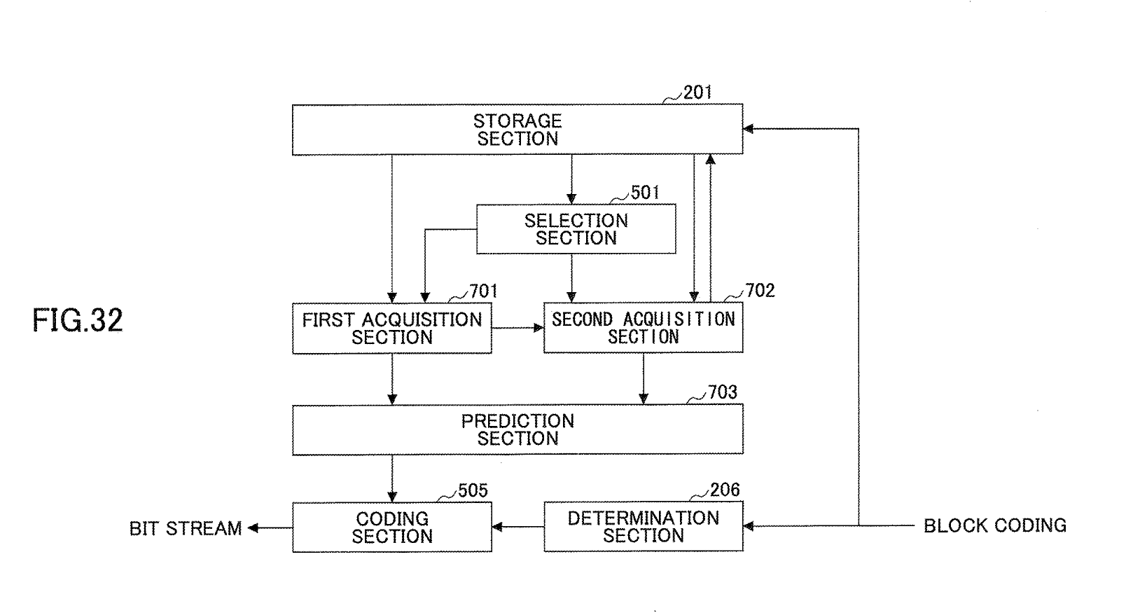

Next an image coding device according to a seventh embodiment is described. The configuration of the image coding device according to the seventh embodiment is similar to that illustrated in FIG. 8. The function of predicting the division mode is illustrated in FIG. 32. FIG. 32 is a block diagram illustrating an example function of predicting the division mode according to the seventh embodiment.

As illustrated in FIG. 32, the image coding device according to the seventh embodiment includes a storage section 201, a selection section 501, a first acquisition section 701, a second acquisition section 702, a prediction section 703, a determination section 206, and a coding section 505. In FIG. 32, the same reference numerals as those in FIGS. 9 and 24 are used to describe the same functions.

In the seventh embodiment, a case is described as an example where B5 picture in FIG. 23 is coded. It is assumed that B4, B6, and P8 pictures are already coded when B5 picture is coded, and those B4, B6, and P8 pictures may be referred to, as the coded image, by B5 picture.

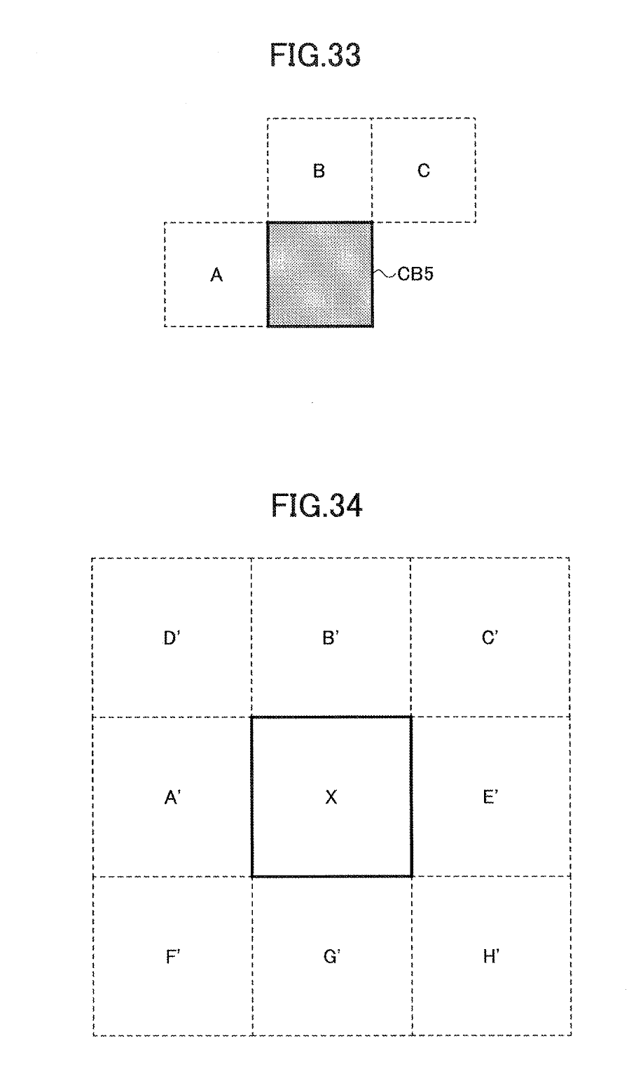

The storage section 201 and the selection section 501 are the same as those in the third and the fifth embodiments. FIG. 33 illustrates an example surrounding blocks in the seventh embodiment. As illustrated in FIG. 33, the first acquisition section 701 acquires the motion vectors A, B, and C and the division modes A, B, and C of the blocks A, B, and C. Here, the block A is located next to and on the left side of the coding target block CBS, the block B is located next to and on the upper side of the coding target block CBS, and the block C is located next to and on the right side of the block B.

The second acquisition section 702 calculates a vector of the intermediate values, the average values or the like based on the plural motion vectors acquired from the first acquisition section 701. This vector is herein called a “tentative motion vector”. Further, when all the motion vectors acquired from the first acquisition section 701 are invalid, the result (output) is zero vector.

The second acquisition section 702 acquires the average vector based on the following formula:

Average vector=(Motion vector A+Motion vector B+Motion vector C)/3

The second acquisition section 702 sets the calculated average vector (pvx, pvy) as the estimation vector PV of the coding target block, and estimates the destination coordinate equivalent to the coding target block to B6 picture. When the coordinate of the coding target block is expressed as (x,y), the destination coordinate is expressed as (x+pvy,y+pvy).

FIG. 34 illustrates example surrounding blocks designated by the second acquisition section 702. Here, to acquire the destination more accurately, the second acquisition section 702 acquires the motion vectors from the surrounding blocks A′ through H′, including block X including the destination coordinate (x+pvy,y+pvy), of B6 picture to B4 picture. All the information of the coded image may be used; therefore, the region where the coding information is acquired may be the region which is designated in advanced.

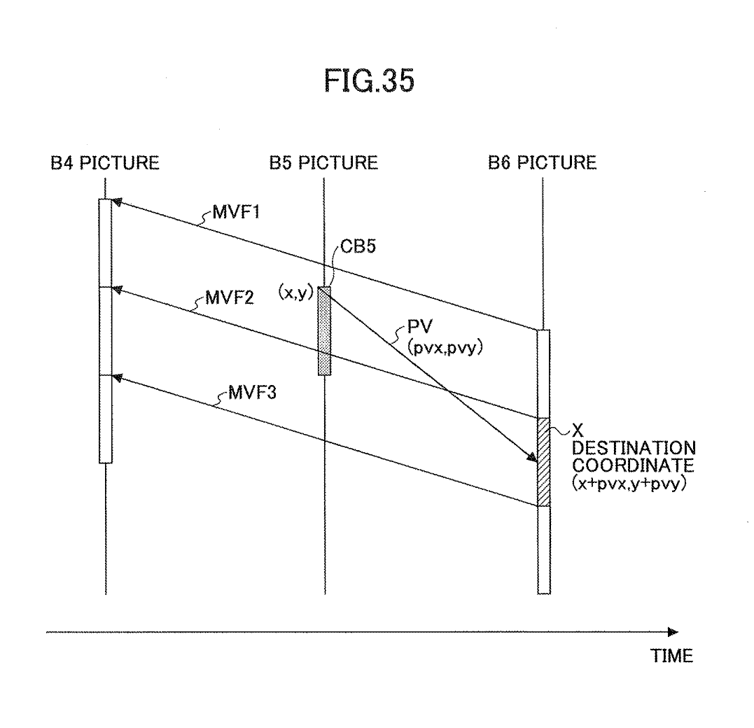

FIG. 35 illustrates an example block acquired by the second acquisition section 702. As illustrated in FIG. 35, the second acquisition section 702 acquires the division mode of block X including motion vector MVF2 which is passing through the coding target block CB5 from among motion vectors MVF1 through MVF3 extending from B6 picture to B4 picture.

If, for example, all the designated blocks A′ through H′ are coded by using the intra prediction, so that there is no motion vector that passes through the coding target block CB5, the division mode is set to invalid.

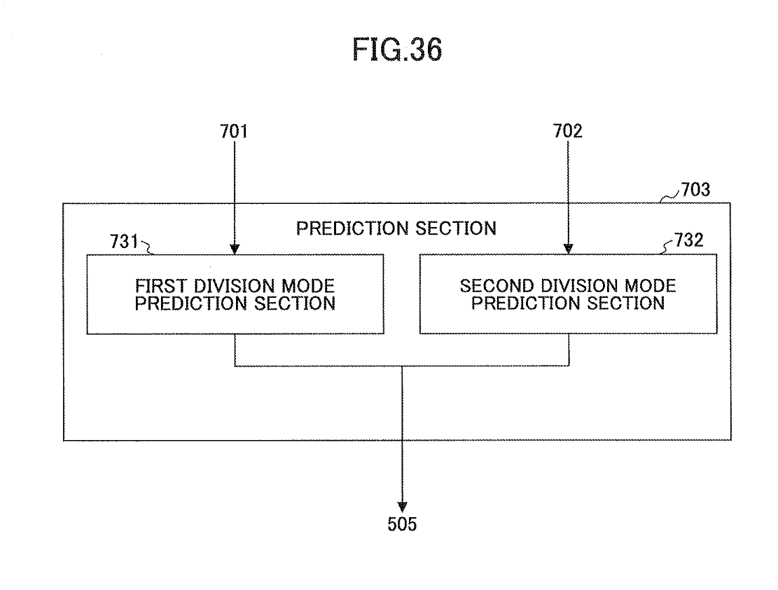

Next, the prediction section 703 is described. FIG. 36 is a block diagram of an example function of the prediction section 703. As illustrated in FIG. 36, the prediction section 703 includes a first division mode prediction section 731 and a second division mode prediction section 732.

When there are plural division modes acquired from the second acquisition section 702, the second division mode prediction section 732 selects the most common division mode and sets the selected division mode as the candidate mode X. When there are more than one division modes having the same number, a priority may be given to the mode to be divided.

The first division mode prediction section 731 selects the most common division mode from among the division mode A of block A, division mode B of block B, and division mode C of block C in the B6 picture acquired from the first acquisition section 701, and sets the selected division mode as a candidate mode Y.

When the candidate mode X is valid, the prediction section 703 puts a higher priority on the candidate mode X than any other candidate mode, and sets the candidate mode X as the prediction mode. When the candidate mode X is invalid, the prediction section 703 sets the candidate mode Y as the prediction mode. This is because there is a higher possibility that the block including the candidate X is similar to the coding target block.

The operations of the determination section 206 and the coding section 505 are similar to those described in the third and the fifth embodiments.

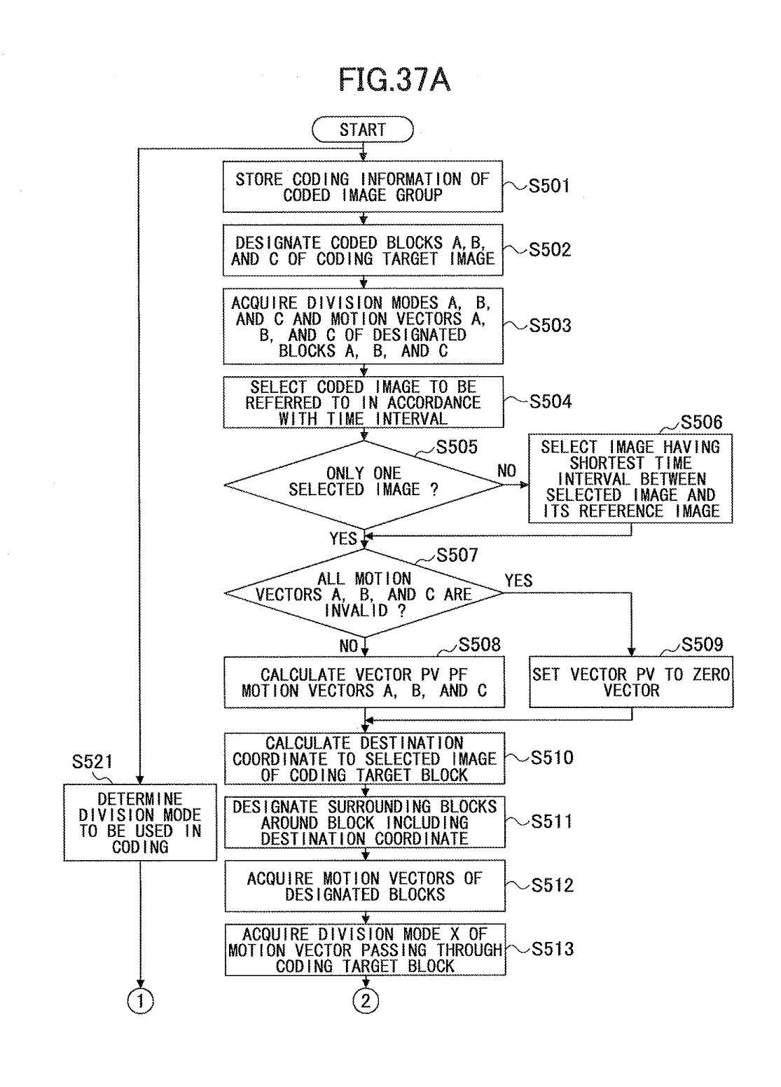

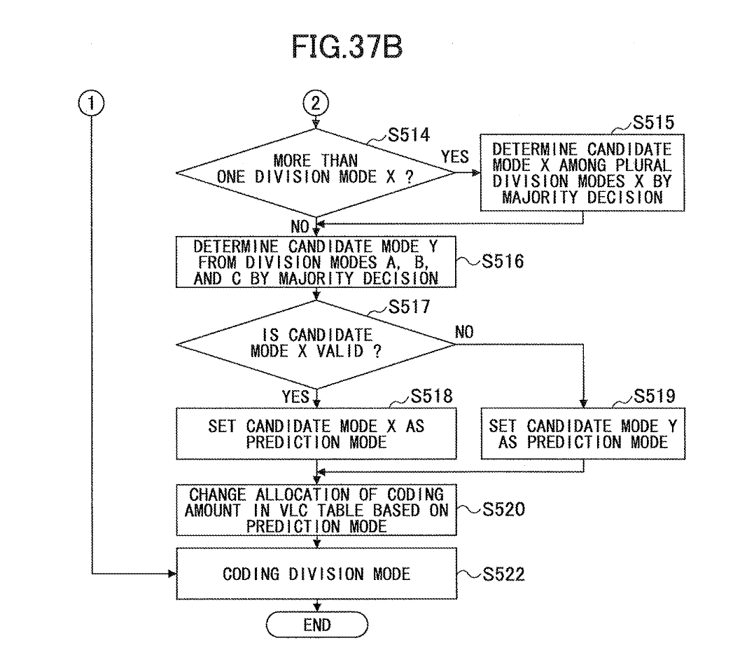

Next, operations of the image coding device according to the seventh embodiment are described. FIGS. 37A and 37B are a flowchart of an example division mode coding process in the seventh embodiment. As illustrated in FIG. 37A, in step S501, the storage section 201 stores the coding information including the motion vector, block type, division mode and the like per each of the blocks of the coded image.

In steps S502 and S503, the first acquisition section 701 acquires the motion vector included in the coding information of the coded block belonging to the coding target image. In the example of FIG. 33, the first acquisition section 701 acquires motion vectors A, B, and C of the blocks A, B, and C, respectively, from the storage section 201.

Here, the block A is located next to and on the left side of the coding target block CBS, the block B is located next to and on the upper side of the coding target block CBS, and the block C is located next to and on the right side of the block B. Here, the motion vector C refers to the motion vector of block C.

In step S504, the selection section 501 selects the coded image (selected image) having a short time interval from the coding target image from among the reference images relative to the coding target image.

In step S505, the selection section 501 determines whether the number of the selected image is one. When it is determined that the number of the selected image is one (YES in step S505), the process goes to step S507. When it is determined that the number of the selected image is more than one (NO in step S505), the process goes to step S506.

In step S506, the selection section 501 selects the coded image having the shortest time interval between the selected image and its reference image.

In step S507, the second acquisition section 702 determines whether the motion vectors A, B, and C, which are acquired from the first acquisition section 701, indicate the selected image selected by the selection section 501 or the reference image in the coding target image direction.

If the motion vectors A, B and C do not indicate any of these images, it is determined that the motion vectors are invalid. Further, when the intra coding is performed, the motion vectors are invalid. Therefore, if it is determined that all the motion vectors A, B, and C are invalid, (YES in step S507), the process goes to step S509. When any of the motion vectors A, B, and C is valid (NO in step S507), the process goes to step S508.

In step S508, the second acquisition section 702 calculates the estimation vector PC by averaging the motion vectors A, B, and C. When determining that the number of valid vectors is only one, the second acquisition section 702 sets the motion vector as the estimation vector PV.

In step S509, the second acquisition section 702 sets the motion vectors A, B, and C as zero vectors.

In step S510, the second acquisition section 702 calculates the destination coordinate to the selected image of the coding target block based on the estimation vector PV.

In step S511, the second acquisition section 702 designates surrounding blocks surrounding the block, which includes the destination coordinate, as the center.

In step S512, the second acquisition section 702 acquires the motion vectors of the designated blocks.

In step S513, the second acquisition section 702 acquires the division mode X of the motion vector passing through the coding target block.

Further, as illustrated in FIG. 37B, in step S514, the second division mode prediction section 732 determines whether the there are more than one division modes X. When it is determined that there are more than one division modes X (YES in step S514), the process goes to step S515. When it is determined that there is only one division mode X (NO in step S514), the process goes to step S516.

In step S515, the second division mode prediction section 732 determines the candidate mode X from the plural division modes X based on majority decision.

In step S516, the first division mode prediction section 731 determines the candidate mode Y from among the division modes A, B, and C based on majority decision.

In step S517, the prediction section 703 determines whether the candidate mode X is valid. When it is determined that the candidate mode X is valid (YES in step S517), the process goes to step S518. When it is determined that the candidate mode X is invalid (NO in step S517), the process goes to step S519.

In step S518, the prediction section 703 puts a higher priority on the candidate mode X rather than the candidate mode Y, and sets the candidate mode X as the prediction mode. This is because that by putting a higher priority on the block which is similar to the coding target block in temporal direction rather than the block closer to the coding target block in spatial direction, there is higher possibility to improve the prediction accuracy.

In step S519, the prediction section 703 selects the candidate more Y as the prediction mode.

In step S520, the coding section 505 changes the allocation of the coding amount in the VLC (Variable Length Coding) table in accordance with the prediction mode. For example, the coding section 505 changes (updates) the VLC table so that the value of the division shape of the prediction mode corresponds to a small sign (value).

In step S521, the determination section 206 determines the division mode of the coding target block base on the block matching.

In step S522, the coding section 505 converts the division mode, which is determined by the determination section 206, into the sign based on the VLC table. The sign is set as the division mode information. The division mode information is included in the bit stream.

Further, after step S510, the second acquisition section 702 may determine whether the destination coordinate is included in the screen. When it is determined that the destination coordinate is out of the screen, the prediction mode of the division mode may be determined by performing the processes from step S103.

Further, to make it simpler, when it is determined that the destination coordinate is out of the screen, the second acquisition section 702 may set division mode X as the division mode indicating the division.

As described above, according to the seventh embodiment, there may be more possibility than in the fifth embodiment that the block similar to the coding target block is found in temporal direction. This is because it is thought that the block having the motion vector passing through the coding target block is more similar to the coding target block. By doing this and accordingly the prediction accuracy of the division mode is improved, the coding amount of codes converted based on the VLC table may be reduce. As a result, it may become possible to improve the coding efficiency.

### Eighth Embodiment

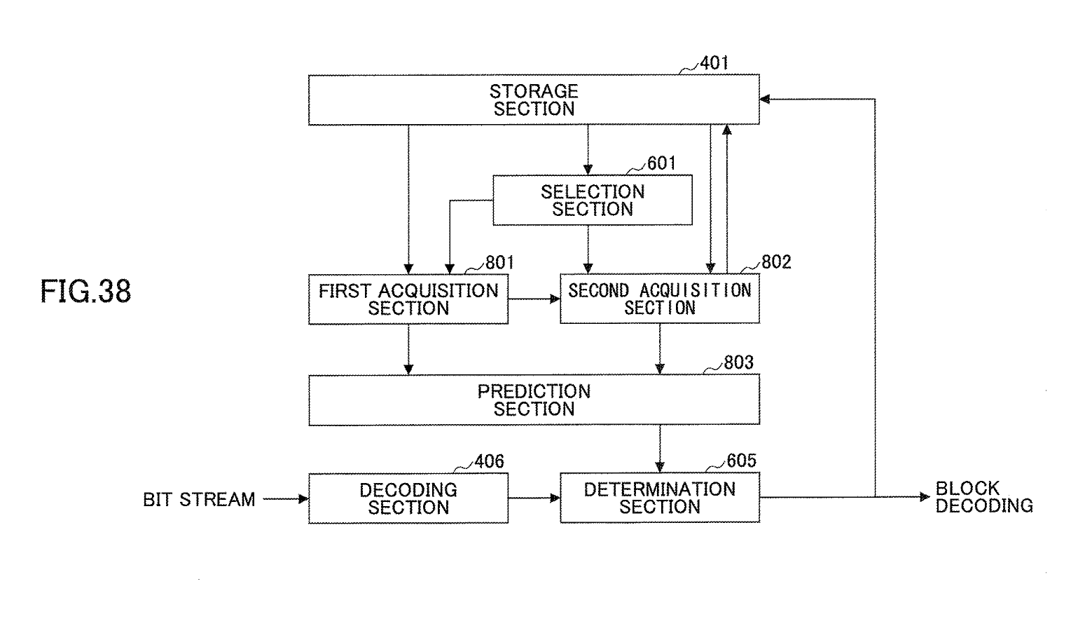

Next, an image decoding device according to an eighth embodiment is described. The configuration of the image decoding device according to the eighth embodiment is similar to that illustrated in FIG. 11. Further, the function of predicting the division mode in the sixth embodiment is described in FIG. 38. FIG. 38 is a block diagram of an example function of predicting the division mode according the eighth embodiment.

As illustrated in FIG. 38, the image decoding device according to the eighth embodiment includes the storage section 401, the selection section 601, a first acquisition section 801, a second acquisition section 802, a prediction section 803, the decoding section 406, and the determination section 605. Here, in FIG. 38, the same reference numerals are used as those in FIGS. 12 and 30 to describe the same functions.

Further, the image decoding device according to the eighth embodiment decodes the bit stream which is coded by the image coding device according to the seventh embodiment.

The storage section 401 and the selection section 601 are the same as those in the fourth and the sixth embodiments.

The first acquisition section 801 acquires the motion vectors A, B, and C and the division modes A, B, and C of the blocks A, B, and C, respectively. Here, the block A is located next to and on the left side of the decoding target block, the block B is located next to and on the upper side of the decoding target block, and the block C is located next to and on the right side of the block B.

The second acquisition section 802 calculates a vector of the intermediate values, the average values or the like based on the plural motion vectors acquired from the first acquisition section 801. Further, when all the motion vectors acquired from the first acquisition section 801 are invalid, the result (output) is zero vector.

The second acquisition section 802 acquires the average vector based on the following formula:

Average vector=(Motion vector A+Motion vector B+Motion vector C)/3

The second acquisition section 802 sets the calculated average vector (pvx, pvy) as the estimation vector PV of the decoding target block, and estimates the destination coordinate equivalent to the decoding target block to the selected picture. When the coordinate of the coding target block is expressed as (x,y), the destination coordinate is expressed as (x+pvy,y+pvy).

Here, to acquire the destination more accurately, the second acquisition section 802 acquires the motion vector in the direction from the selected image to the decoding target image from among the motion vectors of the surrounding blocks A′ through H′ surrounding the block X including the destination coordinate (x+pvy,y+pvy). The region where the decoding information is acquired to use all the information of the decoded images may be designated in advanced.

The second acquisition section 802 acquires the division mode of block X including motion vector which is passing through the decoding target block from among motion vectors extending from the selected image to the decoding target image. If, for example, all the designated blocks A′ through H′ are coded by using the intra prediction, or if there is no motion vector that passes through the decoding target block, the division mode is set to invalid.

When there are plural division modes acquired from the second acquisition section 802, the prediction section 803 selects the most common division mode and sets the selected division mode as the candidate mode X. When there are more than one division modes having the same number, a priority may be given to the mode to be divided.

The prediction section 803 selects the most common division mode from among the division mode A of block A, division mode B of block B, and division mode C of block C in the decoding target image acquired from the first acquisition section 801, and sets the selected division mode as a candidate mode Y.

When the candidate mode X is valid, the prediction section 803 puts a higher priority on the candidate mode X than any other candidate mode, and sets the candidate mode X as the prediction mode. When the candidate mode X is invalid, the prediction section 703 sets the candidate mode Y as the prediction mode.

The operations of the decoding section 406, and the determination section 605 are similar to those described in the fourth and the sixth embodiments.

By doing as described above, it may become possible to decode the bit stream generated by the image coding described in the seventh embodiment.

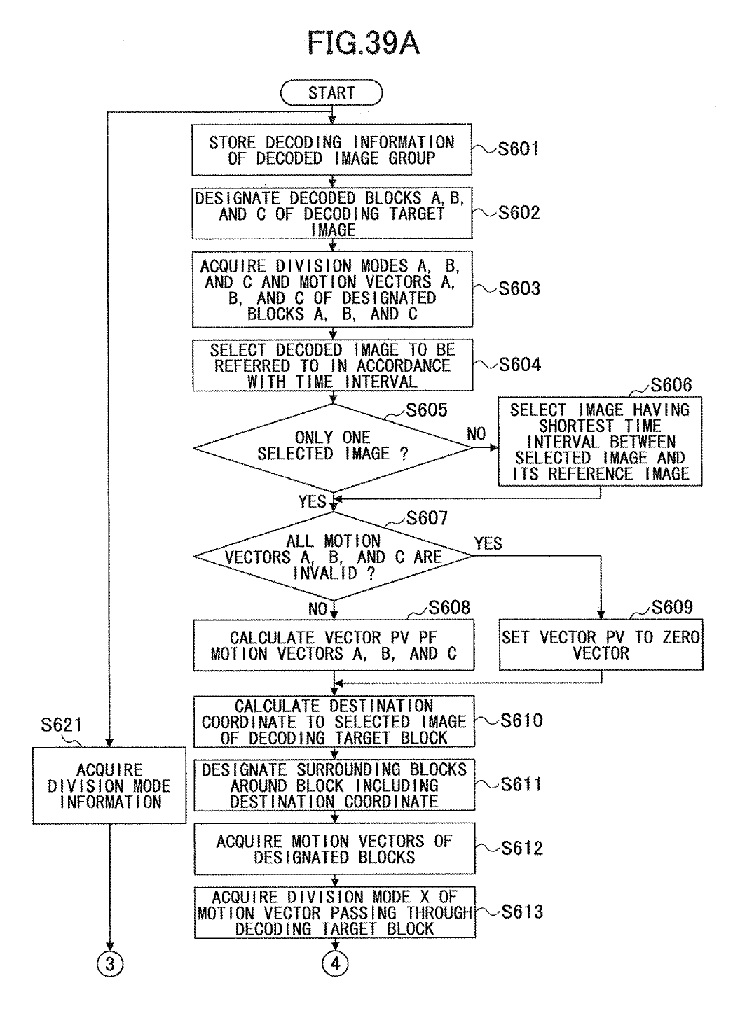

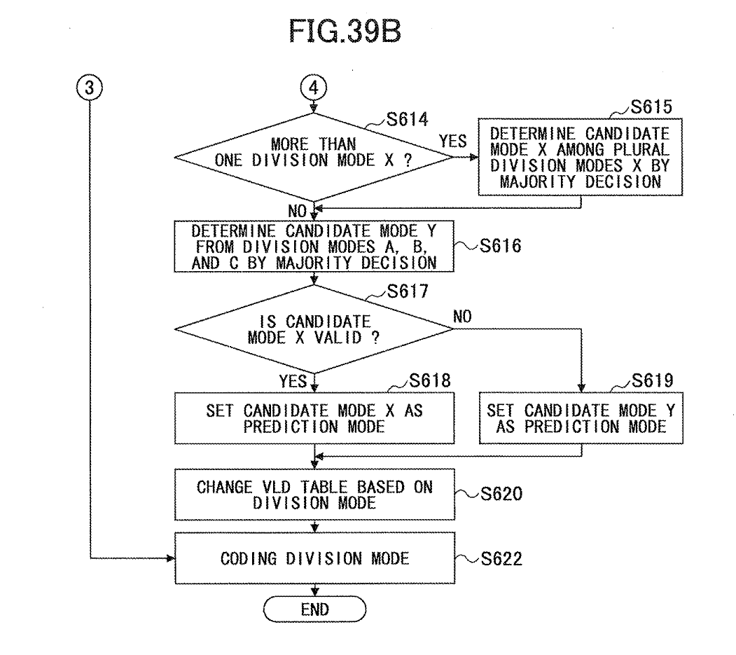

Next, operations of the image decoding device according to the eighth embodiment are described. FIGS. 39A and 39B are a flowchart of an example division mode decoding process in the eighth embodiment.

As illustrated in FIG. 39A, in step S601, the storage section 401 stores the decoding information including the motion vector, block type, division mode and the like per each of the blocks of the decoded image.

In steps S602 and S603, the first acquisition section 801 acquires the motion vector included in the decoding information of the decoded block belonging to the decoding target image from the storage section 401. For example, the first acquisition section 801 acquires motion vectors A, B, and C of the blocks A, B, and C, respectively, which surround (are next to) the decoding target block, from the storage section 201. Here, the block A is located next to and on the left side of the decoding target block, the block B is located next to and on the upper side of the decoding target block, and the block C is located next to and on the right side of the block B.

In step S604, the selection section 601 selects the decoded image (selected image) having a short time interval from the decoding target image from among the reference images relative to the decoding target image.

In step S605, the selection section 601 determines whether the number of the selected image is one. When it is determined that the number of the selected image is one (YES in step S605), the process goes to step S607. When it is determined that the number of the selected image is more than one (NO in step S605), the process goes to step S606.

In step S606, the selection section 601 selects the decoded image having the shortest time interval between the selected image and its reference image.

In step S607, the second acquisition section 802 determines whether the motion vectors A, B, and C, which are acquired from the first acquisition section 801, indicate the selected image selected by the selection section 501 or the reference image in the decoding target image direction.

If the motion vectors A, B and C do not indicate any of these images, it is determined that the motion vectors are invalid. Further, when the intra coding is performed, the motion vectors are invalid. Therefore, if it is determined that all the motion vectors A, B, and C are invalid, (YES in step S607), the process goes to step S609. When any of the motion vectors A, B, and C are valid (NO in step S607), the process goes to step S608.

In step S608, the second acquisition section 802 calculates the estimation vector PV by averaging the motion vectors A, B, and C. When determining that the number of valid vectors is only one, the second acquisition section 802 sets the motion vector as the estimation vector PV.

In step S609, the second acquisition section 802 sets the motion vectors A, B, and C as zero vectors.

In step S610, the second acquisition section 802 calculates the destination coordinate to the selected image of the decoding target block based on the estimation vector PV.

In step S611, the second acquisition section 802 designates surrounding blocks surrounding the block, which includes the destination coordinate, as the center.

In step S612, the second acquisition section 802 acquires the motion vectors of the designated blocks.

In step S613, the second acquisition section 802 acquires the division mode X of the motion vector passing through the decoding target block.

Further, as illustrated in FIG. 39B, in step S614, the prediction section 803 determines whether there are more than one division modes X. When it is determined that there are more than one division modes X (YES in step S614), the process goes to step S615. When it is determined that there is only one division mode X (NO in step S614), the process goes to step S616.

In step S615, the prediction section 803 determines the candidate mode X from the plural division modes X based on majority decision.

In step S616, the prediction section 803 determines the candidate mode Y from among the division modes A, B, and C based on majority decision.

In step S617, the prediction section 803 determines whether the candidate mode X is valid. When it is determined that the candidate mode X is valid (YES in step S617), the process goes to step S618. When it is determined that the candidate mode X is invalid (NO in step S617), the process goes to step S619.

In step S618, the prediction section 803 puts a higher priority on the candidate mode X rather than the candidate mode Y, and sets the candidate mode X as the prediction mode.

In step S619, the prediction section 703 selects the candidate more Y as the prediction mode.

In step S620, the determination section 605 changes (updates) the VLD (Variable Length Decoding) table based on the prediction mode. For example, the determination section 605 changes the VLD table so that the division mode indicating the division shape of the prediction mode is ranged in a higher position.

In step S621, the decoding section 406 decodes the bit stream, and acquires the division mode information of the decoding target block.

In step S622, the determination section 605 converts the signs, which are indicated by the division mode information determined by the decoding section 406, into the division modes based on the VLD table. By doing this, the determination section 605 may determine the division modes.

Further, after step S610, the second acquisition section 802 may determine whether the destination coordinate is included in the screen. When it is determined that the destination coordinate is out of the screen, the prediction mode of the division mode may be determined by performing the processes from step S203 of FIG. 22. Further, to make it simpler, when it is determined that the destination coordinate is out of the screen, the second acquisition section 802 may set division mode X as the division mode indicating the division.

As described above, according to the eighth embodiment, in response to the coding in which the prediction accuracy of the division mode is enhanced, the division mode of the decoding target block may be determined.

### Modified Embodiment

Next, a modified embodiment is described. In this modified embodiment, by recoding a program, which realizes the image coding method or the image decoding method as described above, into a recording medium, the processes described in the above embodiments may be executed in a computer system or the like.

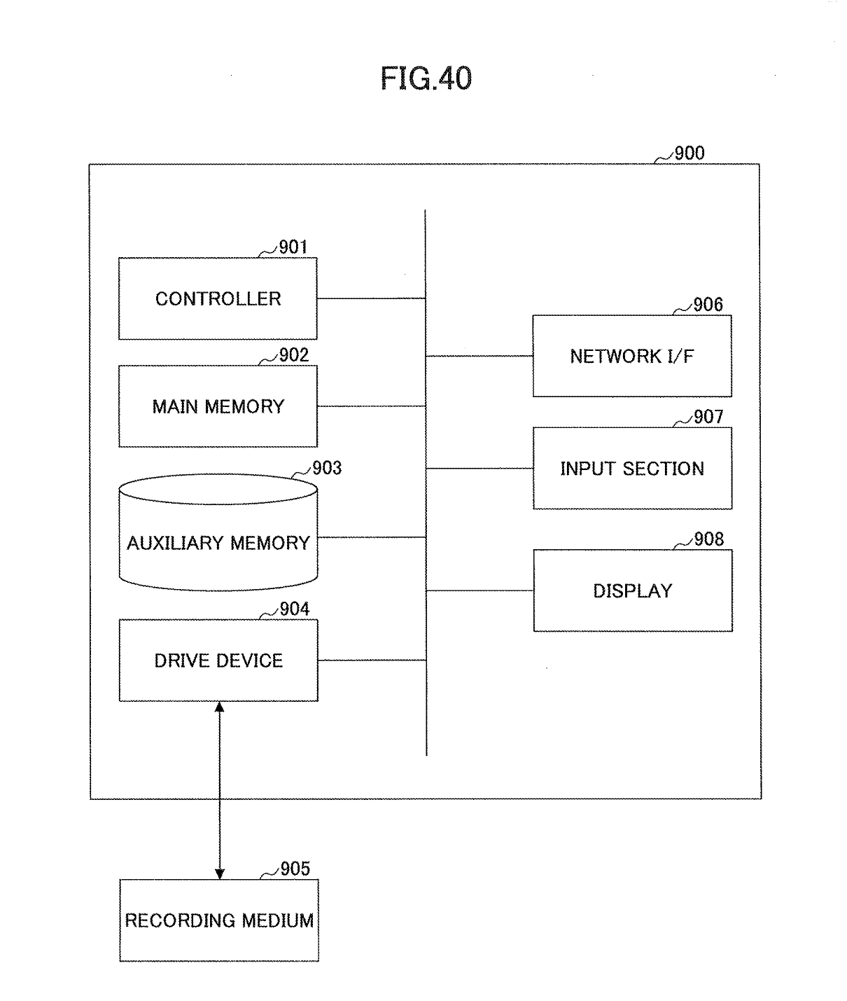

FIG. 40 illustrates an example configuration of an information processing apparatus 900. As illustrated in FIG. 40, the information processing apparatus 900 includes a controller 901, a main memory 902, an auxiliary memory 903, a driving device 904, a network interface (I/F) 906, an input section 907, and a display 908. Those elements are connected to each other via a bus so that they can mutually transmit and receive data.

The controller 901 is a Central Processing Unit (CPU) that controls various devices and calculations and processes various data. Also, the controller 901 serves as an arithmetic unit that executes programs stored in the main memory 902 and the auxiliary memory 903, and inputs data from the input section 907 or a storage device so as to perform calculations and processing on the data and output the calculated and processed data to the display 908 or such a storage device.

The main memory 902 may be a Read-Only memory (ROM), a Random Access Memory (RAM) or the like, and is a memory device storing or temporarily storing an OS, which is a fundamental software, programs such as an application software, which are executed by the controller 901, and data.

The auxiliary memory 903 is a storage device such as a Hard Disk Drive (HDD) storing data related to the application software.

The driving device 904 reads a program from a recoding medium 905 such as a flexible disk and installs (stores) the program in the storage device or the like.

The recoding medium 905 stores a predetermined program. The program stored in the recoding medium 905 is installed in the information processing apparatus 900 via the driving device 904, so that the installed predetermined program may be executed by the information processing apparatus 900.

The network I/F 906 is an interface between the information processing apparatus 900 and a peripheral device having a communication function and being connected to the information processing apparatus 900 via a network such as a Local Area Network (LAN), a Wide Area Network (WAN) or the like formed of data transmission paths such as wired and/or wireless lines.

The input section 907 includes a keyboard, which includes cursor keys, number (numeric) keys, various function keys and the like, a mouse to, for example, select keys on a display screen, a slice pad and the like. Further, the input section 907 is an interface through which a user inputs instructions and data to the controller 901.

The display 908 is, for example, a Cathode Ray Tube (CRT), a Liquid Crystal Display (LCD) or the like to display, for example, data in response to the inputs of the instructions and data by the user.

As described above, the image coding process or the image decoding process as described above may be realized by a program that may cause a computer to execute the process. Such a program may be downloaded from a server to be installed into a computer. By doing this, the image coding process or the image decoding process as described above may be realized (performed).

Further, by recording the program in the recoding medium 905, so that the program stored in the recoding medium 905 may be read by a computer or a mobile terminal, the image coding process or the image decoding process as described above may also be realized (performed).

The recoding medium 905 may be any of the various types of recoding media including media, that optically, electronically, or magnetically record data, such as a CD-ROM, a flexible disk, and a magneto-optical disk, and also a semiconductor memory, that electronically record data, such as a Read-Only Memory (ROM) and a flash memory. Further, the image coding process or the image decoding process as described in the above embodiments may be implemented in one or more integrated circuits.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of superiority or inferiority of the invention. Although the embodiments of the present inventions has been described in detail, it is to be understood that various changes, substitutions, and alterations could be made hereto without departing from the spirit and scope of the invention.

What is claimed is:

1. A method for decoding an image divided into plural blocks, the method comprising:
acquiring decoding information of a decoded block in a decoding target image from a storage unit that stores the decoding information of the decoded block and decoding information of blocks in plural decoded images;
selecting a decoded image from the plural decoded images;
acquiring decoding information of a corresponding block in the selected decoded image from the storage unit;
predicting a division mode, which indicates a division shape of a decoding target block, by using the acquired decoding information of the decoded block and the acquired decoding information of the corresponding block;
decoding division mode information, which indicates the division mode of the decoding target block based on coded data, and
determining the division mode of the decoding target block based on the predicted division mode and the decoded division mode information.

2. The method according to claim 1,
wherein, in the selecting, a decoded image having a shortest time interval from the decoding target image is selected.

3. The method according to claim 1,
wherein the corresponding block comprises a same-position block located at a same position as that of the decoding target block and a surrounding block located around the same-position block.

4. The method according to claim 3,
wherein, in the predicting, when the division mode included in the decoding information of the decoded block is the same as the division mode included in the decoding information of the surrounding block located at a same position as the decoded block, the division mode of the same-position block is set as the predicted division mode.

5. The method according to claim 1,
wherein, in the selecting, a decoded image having a shortest time interval from a reference image thereof is selected.

6. The method according to claim 5,
wherein, in acquiring the decoding information of the corresponding block, a motion vector of the decoded block is acquired, a tentative motion vector is generated based on the acquired motion vector, and a block, which is indicated by the tentative motion vector from the decoding target block, is set as the corresponding block.

7. The method according to claim 6,
wherein, in acquiring the decoding information of the predetermined block, one of surrounding blocks including the block indicated by the tentative motion vector, which one of the surrounding block includes a motion vector passing through the decoding target block, is set as the corresponding block.

8. The method according to claim 7,
wherein, in the predicting, the division mode included in the decoding information of the corresponding block is preferentially selected as the predicted division mode over the division mode included in the decoding information of the decoded block.

9. The method according to claim 1,
wherein, in the determining, the division mode is determined based on a sign indicated by the division mode information and a decoding table where division modes are associated with signs;
wherein the decoding table is changed such that a coding amount of the predicted division mode becomes less than coding amounts of other division modes.

10. The method according to claim 1,
wherein the division mode information indicates whether the division mode of the decoding target block matches the predicted division mode;
wherein in the determining, the predicted division mode is selected as the determined division mode if the division mode of the decoding target block matches the predicted division mode, and a division mode other than the predicted division mode is selected as the determined division mode if the division mode of the decoding target block does not match the predicted division mode.

11. A method for coding an image divided into plural blocks, the method comprising:
acquiring coding information of a coded block from a storage unit that stores the coding information of the coded block in a coding target image and coding information of blocks in plural coded images;
selecting a coded image from the plural coded images;
acquiring coding information of a corresponding block in the selected coded image from the storage unit;
predicting a division mode, which indicates a division shape of a coding target block, by using the acquired coding information of the coded block and the acquired coding information of the corresponding block;
determining a division mode to be used in the coding target block; and
coding division mode information of the coding target block based on the predicted division mode and the determined division mode.

12. An image decoding device for decoding an image divided into plural blocks, comprising:
a storage unit configured to store decoding information of a decoded block in a decoding target image and decoding information of blocks in plural decoded images;
a first acquisition unit configured to acquire the decoding information of the decoded block from the storage unit;
a selection unit configured to select a decoded image from the plural decoded images;
a second acquisition unit configured to acquire decoding information of a corresponding block in the selected decoded image from the storage unit;
a prediction unit configured to predict a division mode, which indicates a division shape of a decoding target block, by using the decoding information of the decoded block acquired by the first acquisition unit and the decoding information of the corresponding block acquired by the second acquisition unit;
a decoding unit configured to decode division mode information, which indicates the division mode of the decoding target block based on coded data, and
a determination unit configured to determine the division mode of the decoding target block based on the division mode predicted by the prediction unit and the division mode information decoded by the decoding unit.

13. An image coding device for coding an image divided into plural blocks, comprising:
a storage unit configured to store coding information of a coded block in a coding target image and coding information of blocks in plural coded images;
a first acquisition unit configured to acquire the coding information of the coded block from the storage unit;
a selection unit configured to select a coded image from the plural coded images;
a second acquisition unit configured to acquire coding information of a corresponding block in the selected coded image from the storage unit;
a prediction unit configured to predict a division mode, which indicates a division shape of a coding target block, by using the coding information of the coded block acquired by the first acquisition unit and the coding information of the corresponding block acquired by the second acquisition unit;
a determination unit configured to determine a division mode to be used in the coded target block; and
a coding unit configured to code division mode information of the coding target block based on the division mode predicted by the prediction unit and the division mode determined by the determination unit.

14. A computer-readable recording medium storing a program causing a computer to execute a method according to claim 1.

15. A computer-readable recording medium storing a program causing a computer to execute a method according to claim 11.
